(19) United States
(12) Patent Application Publication
(10) Pub. No.: US 2004/0263790 A1
(43) Pub. Date: Dec. 30, 2004

(54) Apparatus and methods for mounting and aligning the optical elements of a projection image display system

(76) Inventors: Ronald R VanOverloop, West Chester, OH (US); Douglas M. Reinert, Bethel, OH (US); David M. Shively, Cincinnati, OH (US); E. Gregory Fulkerson, Amelia, OH (US); Blake E. Sansbury, Cincinnati, OH (US); Mark E. Giesey, Ft. Thomas, KY (US)

Correspondence Address: 3M INNOVATIVE PROPERTIES COMPANY, PO BOX 33427, ST. PAUL, MN, 55133-3427, US

(21) Appl. No.: 10/488,218

(22) PCT Filed: Aug. 9, 2002
(86) PCT No.: PCT/US02/25461

Related U.S. Application Data
(60) Provisional application No. 60/316,192, filed on Aug. 30, 2001.

(51) Int. Cl. G03B 21/00

(52) U.S. Cl. 353/31

(57) ABSTRACT

Apparatus and methods for mounting and aligning the optical elements of a light engine (20) for a projection image display system (21) to produce a focused, converging, high-resolution and coherent full-color image with optimized contrast and brightness. The optical elements of an illumination subsystem of the light engine are aligned to optimize the efficiency and properties of light transferred from a light source (26) to a set of three imagers (38, 40, 42). The optical elements of a projection subsystem (24) of the light engine (20) are aligned to optimize the synthesis of the three primary color components output by the imagers (38, 40, 42) to project the full-color image onto a projection screen. The alignment is achieved by apparatus and methods that accurately position the optical elements and that precisely adjust the relative positions and angular orientations of certain of the optical elements.

### FIELD OF THE INVENTION

The present invention relates generally to projection image display systems and, more particularly, to apparatus and methods for mounting and aligning the optical elements of a light engine for a projection image display system.

### BACKGROUND OF THE INVENTION

Projection image display systems are used to display images on a single large projection screen, such as a large television screen or a computer display. Projection image display systems are either rear or forward projector units that, in a familiar conventional design, project images from three image sources, such as cathode ray tubes. The image sources supply each of the red, green and blue primary color images through three separate projection lenses. The primary color images are overlapped on the projection screen to construct a composite full-color image. In forward projector units, the primary color images are projected from an image source onto the front side of a reflection-type projection screen that reflects the image toward a viewer positioned in front of the screen. In rear projector units, the primary color images are projected onto the rear side of a transmission-type projection screen and transmitted toward a viewer in front of the screen. Among other attributes, such projection image display systems are bulky and heavy due to the need for three separate image sources.

Simplified projection image display systems have been proposed that utilize a single light engine and a single exit pupil. Projection image display systems based upon a single light engine reduce the problem of color shift among the three primary color images and simplify the design of the projection screen in that the screen does not need to perform mixing of the colors from the three lens systems. However, the optical elements of the light engine must be precisely aligned and oriented along an optical path between a lamp and the projection screen to create and project a satisfactory full color image using a single light engine.

Conventional projection image display systems utilizing light engines are deficient in the mounting and alignment of the optical elements and components of the light system so that the images are not optimally focused, are not adequately color converged, and lack the desired contrast. Satisfactory apparatus and methods are heretofore not available for aligning the optical elements. Often, artifacts of the assembly process can unintentionally introduce misalignment of the optical elements. For example, during assembly of the light engine, a properly aligned or oriented optical element can be misaligned or misoriented simply by tightening a fastener to secure the optical element in the aligned position. A misalignment on the order of microns (μm) of a key optical element in the light engine can significantly degrade an attribute, such as brightness, color convergence, and contrast, of the full-color image that the projection image display system projects onto the projection screen.

Moreover, conventional projection image display systems are inefficient in their use of the luminous flux output by an illumination subsystem. For example, imagers that modulate the luminous flux to provide the primary color images must be fully illuminated with a luminous flux that is bright and uniform. Otherwise, the primary color image will have a poor quality and degrade the quality of the full-color image. In conventional projection image display systems, the luminous flux is overscanned at the location of the imagers by a given percentage to accommodate alignment errors by making the area of the light greater than the active area of the image. Photons of the overscanned beam of light that miss the imager are wasted and thereby reduce the percentage of the luminous flux output by the illumination system that is available for imaging.

Thus, there is a need for apparatus and methods for precisely mounting and aligning the optical elements of a single light-engine projection image display system such that the three primary color images can be produced and precisely synthesized to produce an optimized full-color image.

### SUMMARY OF THE INVENTION

The present invention overcomes the foregoing and other shortcomings and drawbacks of alignment systems and alignment methods for the optical elements of a projection image display system utilizing a light engine. While the invention will be described in connection with certain embodiments, it will be understood that the invention is not limited to these embodiments. On the contrary, the invention includes all alternatives, modifications and equivalents as may be included within the spirit and scope of the present invention.

According to the present invention, a projection image display system is provided that projects with aligning and mounting features enabling a high-contrast, high-resolution full-color image to be projected onto a viewing surface. The display system includes an illumination subsystem, a color separation subsystem, three modulating imagers, a color recombination subsystem and a projection lens assembly. The illumination subsystem is operable to emit a beam of visible light and includes a cold mirror for reflecting the beam of visible light along a first optical axis. The color-separation subsystem includes an input optical element positioned relative to the first optical axis so as to receive the beam of visible light. The color-separation optical system is operable to separate the beam of visible light into three beams of primary-color light. The three modulating imagers are positioned relative to the color-separation optical system so as to receive a respective one of the three beams of primary-color light. Each of the three modulating imagers includes a rectangular active area operable to modulate the respective beam of primary-color light based on a given image signal to produce a respective beam of modulated primary-color light. The color recombination subsystem is operable to receive and combine the three beams of modulated primary-color light to form the full-color image. The projection lens assembly is operable to project the full-color image synthesized by the color recombination optical system onto the viewing surface.

In certain embodiments of the projection image display system, the color-separation subsystem, the three modulating imagers, the color recombination subsystem, and the projection lens assembly are mounted on a single mounting plate. The cold mirror is moveable relative to the input optical element for aligning a first dimension of each of the beams of primary color light with a first dimension of the rectangular active area of the respective one of the three light-modulating imagers. The mounting plate is moveable in a first direction relative to the cold mirror for aligning a second dimension of each of the beams of primary color light with a second dimension of the rectangular active area of the respective one of the three light-modulating imagers.

In one embodiment of the display system, the illumination subsystem includes an optical element operable to angularly orient the first dimension of each of the beams of primary color light with the first dimension of the respective one of the three light-modulating imagers. In another embodiment of the display system, the mounting plate is moveable in a second direction relative to the cold mirror for focusing each of the beams of primary color light at the respective locations of the rectangular active areas of the three light-modulating imagers. In yet another embodiment of the display system, the color-combining subsystem includes one or more optical elements operable to adjust the contrast of the three beams of modulated primary-color light before they are projected as the full-color image onto the viewing surface by the projection lens assembly. In yet another embodiment of the display system, the input optical element of the color-separation subsystem comprises a polarizing beamsplitter and the color-separation subsystem includes an input side of a quad-prism assembly. In yet another embodiment of the display system, the color-combining subsystem includes an output side of a quad-prism assembly.

In yet another embodiment of the display system, the illumination subsystem includes a light source with a focal point and an optical integrator having a planar input face. The light source and the optical integrator are aligned along a second optical axis. The light source is moveable in a plane substantially parallel to the planar input face of the optical integrator for substantially aligning the focal point of the light source with a location in the plane of the planar input face that optimizes the transmission of light by the optical integrator.

According to another aspect of the present invention, an optical assembly for an illumination subsystem of a projection image display system is provided that comprises a lamp housing having an opening, a reflector, an optical element operable to alter a property of the light in the optical path of the illumination system, a light source operable to emit light for reflection by the reflector, and a circumferential mounting flange holding the reflector in a position to reflect light from the light source through the opening in the lamp housing. The reflector, which may be ellipsoidal, has a focal point for the reflection of light and a first optical axis along which the focal point lies. The optical element, which may be an optical integrator, has a second optical axis that is capable of being optically aligned with the first optical axis of the reflector to establish an aligned condition and a planar end face positioned at the focal point of the reflector. The circumferential mounting flange is moveable in two orthogonal directions relative to the lamp housing and in a plane at least substantially parallel to the planar end face of the optical element for establishing the aligned condition.

According to another aspect of the present invention, a mounting assembly is provided for pivotally mounting an optical element in an illumination subsystem of a projection image display system, in which the optical element, such as an optical integrator, is operable to alter a property of the light in the optical path of the illumination system. The mounting assembly comprises a body member having a first arcuate bearing surface, a cradle adapted to support the optical element on the body member, and a mounting element configured to releasably secure the cradle to the body member at a selected tilt angle. The cradle has a second arcuate bearing surface pivotal relative to the first bearing surface of the body member and rotatable within the body member over a range of tilt angles for rotating the optical element to a desired angular orientation. The mounting element has a released condition to allow the cradle to move relative to the body member and a tightened condition to secure the cradle to the body member in the desired angular orientation. The cradle is substantially free of torque transferred from the mounting element to the cradle when the tightened condition is established so that the desired angular orientation is not misaligned during tightening. Preferably, the cradle has a pair of second arcuate bearing surfaces that are pivotal against a pair of first arcuate bearing surfaces on the body member.

According to another aspect of the present invention, an optical device for aligning a beam of light with an imager in a projection image display system is provided. The optical device comprises a light source operable to emit a beam of light, a mirror held in an inclined mount and having a reflective surface, and an optical element receiving the beam of light reflected from the reflective surface. The reflective surface of the mirror is effective to reflect the beam of light in a first direction. The optical element, such as a polarizing beamsplitter, has a planar interface capable of redirecting the beam of light in a second direction different than the first direction, wherein the redirected beam of light irradiates the imager. The inclined mount is moveable relative to the second optical element to reposition the beam of light reflected from the reflecting surface to thereby change the portion of the planar interface receiving the reflected light so that the second direction is shifted and the redirected light irradiates the imager at a second location different from the first location.

According to another aspect of the present invention, an optical apparatus for an illumination subsystem of a projection image display system is provided that changes the travel direction of a planar beam of incident light. The optical apparatus comprises a light-generating device operable to generate the planar beam of incident light having a cross-sectional area, an optical element positioned relative to the light-generating device to receive the planar beam of incident light, and a mounting plate holding the optical element. The light-generating device directs the planar beam of incident light in a first direction. The optical element has a planar interface, inclined relative to the first direction, that is operable to redirect the planar beam of incident light in a second direction different from the first direction. The mounting plate is moveable relative to the frame along a first axis for changing the location at which the incident beam of light strikes the inclined planar interface and moveable relative to the frame along a second axis for changing the distance between the light-generating device and the optical element.

According to another aspect of the present invention, an optical apparatus is provided for aligning the active surface area of an imager relative to an optical axis in a projection subsystem of a projection image display system and in which the active surface area has a surface normal. The optical apparatus comprises a frame and a mounting bracket collectively holding the imager in a given three-dimensional orientation. One of the frame and the mounting bracket has a plurality of bores, which can be either throughbores or blind bores, arranged about a periphery thereof. The other of the frame and the mounting bracket has a plurality of pins also arranged about a periphery thereof. The pins are capable of being three-dimensionally registered with the bores during an operation to align the surface normal of the active surface area of the imager with the optical axis. Pairs of the pins and the bores are adapted to be secured together to secure the position of the optical element relative to the bracket after the aligned condition is established. For example, the pins and bores may be secured together using a quantity of an adhesive, such as an optical cement or epoxy.

According to another aspect of the present invention, an optical assembly is provided for a projection subsystem of a projection image display system. The optical assembly comprises a light imager having an active surface area, a first end and a second end, the active area emitting light, a quarter-wave plate, and a bracket holding the quarter-wave plate adjacent to the active surface area. The bracket is pivotally attached at a third end to the first end of the light imager so that the polarization device is rotatable relative to the light imager along a first axis. The bracket includes a releasable securing mechanism at a fourth end to the second end of the light imager. The releasable securing mechanism has a pivotal condition and a stationary condition and is configured so that torque applied to the securing mechanism to create the stationary condition is directed along a second axis different from the first axis. This aspect of the present invention aids in optimizing the contrast of the modulated light output by the light imager.

According to another aspect of the present invention, an alignment system is provided for a projection subsystem of a projection image display system. The alignment system includes an imaging device, a projection lens assembly, a bearing washer, and a plurality of threaded fasteners. The imaging device has a first optical axis, a mounting surface and a plurality of threaded openings arranged about the mounting surface. The imaging device is adapted to emit a beam of light at least substantially parallel to the first optical axis. The projection lens assembly has a flange mounted to the mounting surface and positioned to receive the beam of light. The projection lens assembly includes a second optical axis and the flange has a plurality of first throughbores alignable with the threaded openings of the mounting surface. The projection lens assembly is moveable relative to the mounting surface for aligning the first optical axis of the imaging device with the second optical axis of the projection lens assembly to establish an aligned condition. The bearing washer includes a plurality of second throughbores alignable with the first throughbores and alignable with the threaded openings. Each of the plurality of threaded fasteners has a threaded length and a head at one end of the threaded length. The threaded length of each threaded fastener is insertable through the first and the second throughbores for threadable attachment with a respective one of the threaded holes to capture the bearing washer against the flange. The bearing washer is operable to prevent the transfer of torque from the heads of the threaded fasteners to the flange of the projection lens assembly when the fasteners are tightened against the bearing washer and the flange to secure the projection lens assembly in the aligned condition.

According to another aspect of the present invention, an electrical connector clamp is provided for securing an electrical connector in a light source for an illumination subsystem of a projection image display device. The clamp comprises a clamp body having an slotted aperture, a clamp arm, and an arcuate recess. The slotted aperture is dimensioned to receive opposite sides of a circumferential flange of a connector body. The arcuate recess includes a lower surface and an overhanging upper surface separated by a distance sufficient to receive a first side edge of the connector body therebetween. The clamp arm is configured resiliently to secure an outwardly-extending ridge on a second side edge of the connector body. The clamp body secures the electrical connector against pullout forces.

According to another aspect of the present invention, an optical assembly is provided for a projection image display system. The optical system includes a mounting plate formed of a material having a first coefficient of thermal expansion, an optical element formed of a material having a second coefficient of thermal expansion, a first and a second quantity of an adhesive, such as an radiation-curable optical cement, and a first and a second circular disk, which may be transmissive of radiation capable of curing the radiation-curable optical cement. The mounting plate has a first throughbore and a second throughbore located in a spaced relationship. The second coefficient of thermal expansion of the optical element differs from the first coefficient of thermal expansion of the optical element. The first circular disk is positioned in the first throughbore so as to capture the first quantity of adhesive therebetween. The second circular disk is positioned in the second throughbore so as to capture the second quantity of adhesive therebetween. The disks are formed of a material having a third coefficient of thermal expansion which may be between the first and second coefficients of thermal expansion. The interposition of the disks reduces the likelihood that the prisms of the quad-prism assembly will be damaged due to the greater relative expansion of the mounting plate and forces acting on the quad-prism assembly at the adhered points of attachment to the mounting plate.

According to another aspect of the present invention, an optical assembly comprised of an optical element and a mounting plate is provided for a projection image display system. The mounting plate has a first mounting pad and a second mounting pad spaced apart from the first mounting pad. The first and second mounting pads are raised above a recessed surface portion of the mounting plate. A quantity of an adhesive, such as an optical cement or epoxy, is applied to each of the first and the second mounting pads. The optical element is positioned in a desired aligned position with respect to the mounting plate. A first portion of the optical element contacts the adhesive on the first mounting pad and a second portion of the optical element contacts the adhesive on the second mounting pad. After the optical element is positioned in a desired position, the adhesive is curable to affix the optical element in the desired aligned position. In certain embodiments, the mounting device is configured to permit alignment of the optical element in a plane. In other embodiments, the mounting device is configured to permit alignment of the optical element in a plane and tilting of the optical element relative to that plane.

According to another aspect of the present invention, a lens mount is provided for mounting a disk-shaped lens in an illumination subsystem of a projection image display system. The lens mount comprises a body having a first mounting flange with an arcuate first mounting surface and a second mounting flange with an arcuate second mounting surface and a first resilient insert, which may be semi-circular and annular. The first and the second mounting flanges extend away from the body with a spaced relationship to define a recess capable of receiving the disk-shaped lens therein. The first resilient insert is attached to the peripheral rim of the disk-shaped lens and contacts a portion of the first mounting surface. The contact between the resilient insert and the portion of the first mounting surface urges a first portion of the lens against the second mounting surface to ensure proper alignment.

According to the present invention, a method is provided for aligning an incident beam of light relative to an optical element in an illumination subsystem of a projection image display system. The incident beam of light has a cross-sectional area with a first major axis and a first minor axis orthogonal to the first major axis and the optical element has a planar active area with a second major axis and a second minor axis orthogonal to the second major axis, wherein the first major axis is substantially collinear with the second major axis. The method comprises providing a beamsplitter with an inclined planar interface operable to reflect a portion of the incident beam of light as a reflected beam of light having substantially the same cross-sectional profile as the incident beam of light. The reflected beam of light has a third major axis and a third minor axis orthogonal to the third major axis. The first minor axis of the incident beam of light is moved transverse with respect to the inclined planar interface to align the third minor axis of the reflected beam of light with the second minor axis of the active area. The inclined planar interface of the beamsplitter is moved parallel to the first major axis of the incident beam of light to align the third major axis of the reflected beam of light with the second major axis of the active area.

According to the present invention, a method is provided for attaching an optical element to a mounting plate in a projection image display system, wherein the optical element is formed of a material having a first coefficient of thermal expansion, the mounting plate is formed of a material having a second coefficient of thermal expansion, and the second coefficient of thermal expansion differs from the first coefficient of thermal expansion. The method includes providing the mounting plate with a circular throughbore and an oval throughbore having a spaced relationship. The optical element is positioned in a desired aligned position with respect to the mounting plate wherein a portion of the optical element covers one entrance to the oval throughbore and one entrance to the circular throughbore. A quantity of an adhesive, such as an optical cement or an epoxy, is applied in an opposite entrance of the oval throughbore and in an opposite entrance of the circular throughbore. A first disk is placed into the circular throughbore and into contact with one quantity of the adhesive. Similarly, a second disk is placed into the oval throughbore and into contact with another quantity of the adhesive. The first and the second disks are formed of a material having a third coefficient of thermal expansion between the second and the third coefficients of thermal expansion. The adhesive is cured to secure the optical element in the aligned position. Preferably, the adhesive is radiation curable and the first and the second disks are formed of a material that is transmissive of radiation effective to cure the radiation-curable adhesive.

According to the present invention, a method is provided for attaching an optical element to a mounting plate in a projection image display system. The mounting plate is provided with a first mounting pad and a second mounting pad, wherein the first and second mounting pads project above a recessed surface portion of the mounting plate. A quantity of an adhesive is applied on at least each of the first and the second mounting pads. The optical element is positioned in a desired aligned position with respect to the mounting plate in which a first portion of the optical element contacts the adhesive of the first mounting pad and a second portion of the optical element contacts the adhesive of the second mounting pad. The adhesive is cured on at least the first and the second pads to affix the optical element in the desired position.

The apparatus and methods of the present invention are particularly adapted to process unpolarized light from a single light source into a full color image projected onto a projection screen, wherein the three primary color images are precisely overlapped to produce a high-resolution full color image, and the full color image has an optimized contrast and brightness. The apparatus and methods of the present invention permit the optical elements of the light engine to be precisely mounted and aligned to optimize the properties of the full-color image that is projected by the light engine. The precision mounting and alignment of the optical elements converges and registers the primary color images before projection by a single projection lens assembly onto a projection screen. The need for precision is due to the microscopic pixel size of the primary color images, which may vary considerably but may be on the order of about 10 μm. A positional shift in one of the primary color images by a fraction of the pixel size is sufficient to degrade the quality of the full-color image projected by the projection lens assembly. This is in contrast to conventional projection image display systems that combine the magnified primary color images on the large-area projection screen.

The alignment apparatus and methods of the present invention improve focus uniformity, enhance color convergence of the primary color images, and improve image contrast. The alignment apparatus and methods of the present invention also significantly reduce the required overscan of light at the imagers so that the light output by the light source of the illumination subsystem is more efficiently used and the brightness and uniformity of the illumination of the imagers are improved. The alignment apparatus and methods of the present invention also prevent misalignment or misorientation of the optical elements of the light engine, after a desired alignment or orientation is established during assembly, when an operation is performed to secure the optical element in place. As a result, the alignment of the light engine is less likely to be inadvertently degraded during assembly.

The light engine of the present invention offers significant reductions in weight and size over conventional projection image display systems. The apparatus and methods of the present invention provide a lightweight light engine so that a projection image display system based on the light engine is significantly lighter than conventional projection image display systems. The apparatus and methods of the present invention provide a compact light engine so that the footprint of the projection image display system, such as a projection screen television, based on the light engine is smaller than the footprint of a comparable projection image display system of a conventional design.

The above and other objects and advantages of the present invention shall be made apparent from the accompanying drawings and the description thereof.

### BRIEF DESCRIPTION OF THE DRAWINGS

The accompanying drawings, which are incorporated in and constitute a part of this specification, illustrate embodiments of the invention and, together with a general description of the invention given above, and the detailed description of the embodiments given below, serve to explain the principles of the invention.

FIG. 1 is a front perspective view of a light engine of the present invention.

FIG. 2 is a rear perspective view of the light engine of FIG. 1.

FIG. 3 is an exploded perspective view of the light engine of FIGS. 1 and 2.

FIG. 4 is a cross-sectional view taken generally along line 4-4 of FIG. 2.

FIG. 4A is an enlarged cross-sectional view of a portion of the light engine of FIG. 4.

FIG. 4B is an enlarged view of another portion of the light engine of FIG. 4.

FIG. 5 is a bottom disassembled perspective view of a light source for the light engine of FIGS. 1-4.

FIG. 5A is an assembled perspective view of the light source of FIG. 5.

FIG. 5B is an end view of a socket clamp for the light source of FIG. 5.

FIG. 6 is a partially assembled perspective view of the light source of FIGS. 5 and 5A with the removable cover removed to provide access to the fasteners holding the mounting flange to the lamp housing.

FIG. 7 is a side elevational view partially cut-away of the light source for the light engine.

FIG. 8 is an enlarged perspective view of a portion of FIG. 3 showing a cradle holding an optical integrator.

FIG. 9 is a sectional view of the cradle and optical integrator taken generally along line 9-9 in FIG. 2.

FIG. 10 is an exploded perspective view of the projection subsystem of FIGS. 1 and 3.

FIG. 10A is an exploded perspective view of a portion of the projection subsystem of FIG. 10.

FIG. 10B is a cross-sectional view taken generally along line 10B-10B in FIG. 10A, shown with the quad-prism assembly adhesively bonded with the mounting plate.

FIG. 11A is a schematic cross-sectional view illustrating an alternative assembly for the quad-prism assembly and the mounting plate.

FIG. 11B is a schematic cross-sectional view similar to FIG. 11A illustrating an alternative assembly for the quad-prism assembly and the mounting plate.

FIGS. 11C and 11D are schematic cross-sectional views similar to FIG. 11A illustrating another alternative assembly for the quad-prism assembly and the mounting plate.

FIG. 12 is a bottom assembled perspective view of the projection subsystem of FIG. 10.

FIG. 13 is a cross-sectional view taken generally along line 13-13 of FIG. 4.

FIG. 14 is a diagrammatic perspective view illustrating the movement of the polarizing beamsplitter and the cold mirror for aligning the beam of light with the active area of the green imager.

FIG. 15 is a diagrammatic side view of the beam of light directed by the polarizing beamsplitter and the cold mirror FIG. 14.

FIG. 16 is a diagrammatic rear view of the polarizing beamsplitter and the cold mirror of FIG. 14, taken generally along line 16-16 of Fig. FIG. 15.

FIG. 17 is an exploded perspective view of the red imager assembly of FIG. 10.

FIG. 18 is an assembled rear perspective view of the red imager assembly of FIG. 17.

FIG. 19 is an assembled front perspective view of the red imager assembly of FIG. 17.

FIG. 20 is an exploded perspective view of the blue imager assembly of FIG. 10.

FIG. 21 is an assembled front perspective view of the blue imager assembly of FIG. 20.

FIG. 22 is an exploded perspective view of the green imager assembly of FIG. 10.

FIG. 23 is an assembled rear perspective view of the green imager assembly of FIG. 22.

FIG. 24 is an assembled side view of the green imager assembly of FIG. 22.

### DETAILED DESCRIPTION OF THE PREFERRED EMBODIMENT

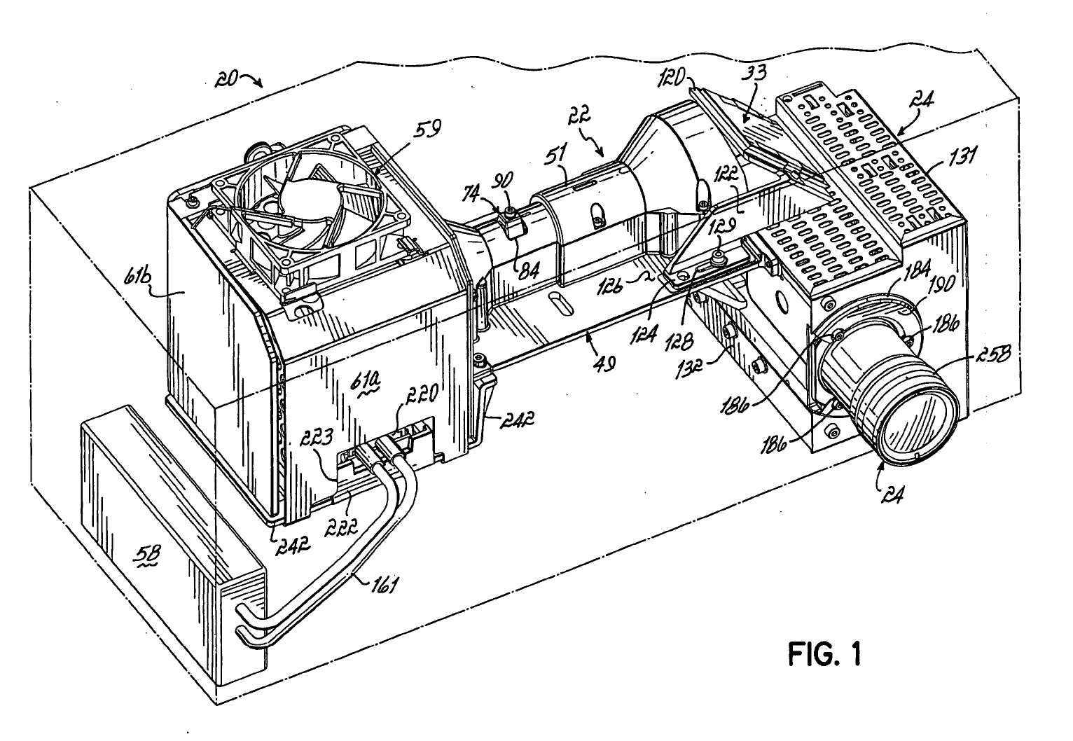

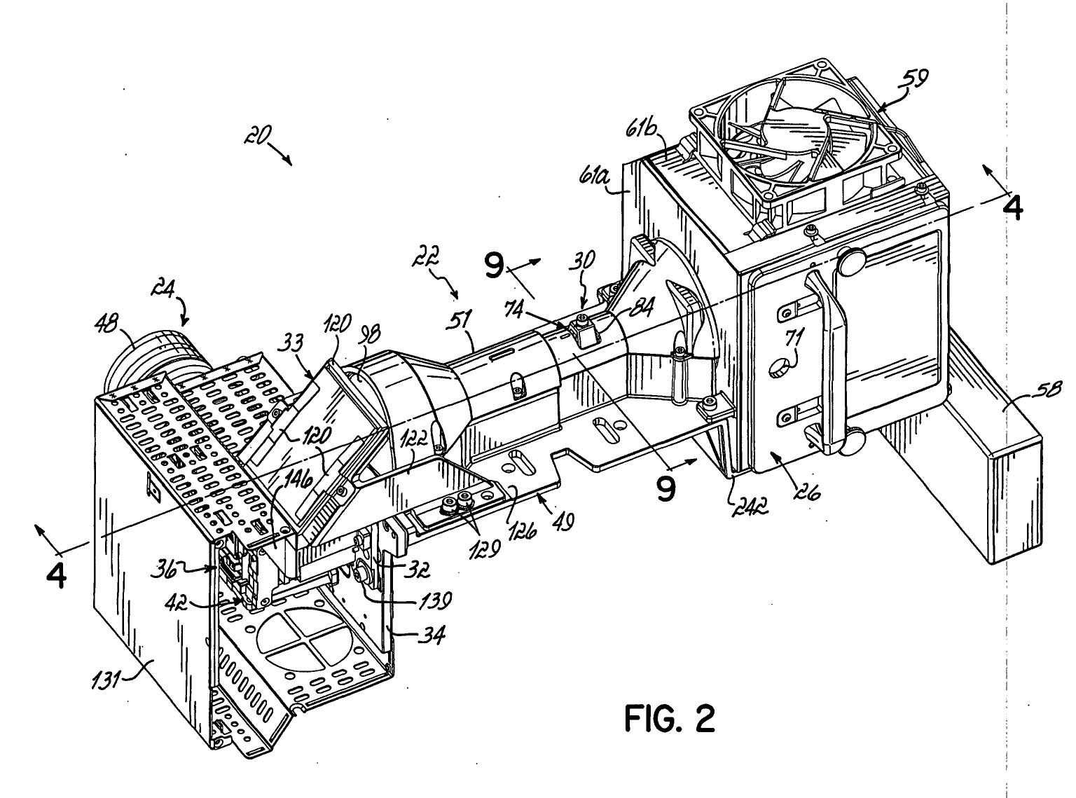

With reference to FIGS. 1-4 and 10, a light engine 20 of the present invention is housed in a projection image display system, schematically represented by reference numeral 21, having the necessary electronics and support components (not shown), such as control electronics for the imagers used in the light engine 20, to operate the light engine 20. The light engine 20 of the present invention consists of the optical elements and support structures forming an illumination subsystem, generally indicated by reference numeral 22, that provides the luminous flux to the imagers and the optical elements and support structures forming a projection subsystem, generally indicated by reference numeral 24, that constructs a full-color image from the light modulated by the imagers. As used hereinafter, optical element is defined as optical part such as lenses, prisms, mirrors, filters, lamps, imagers, and the like, and includes assemblies of multiple optical parts.

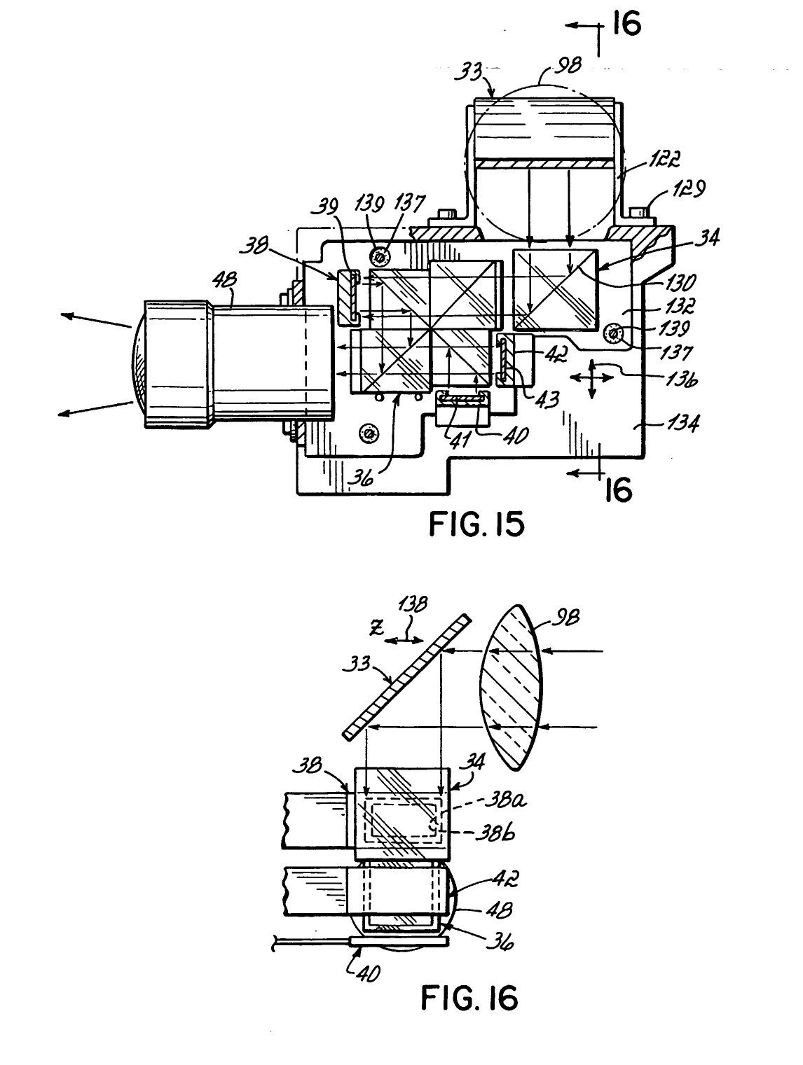

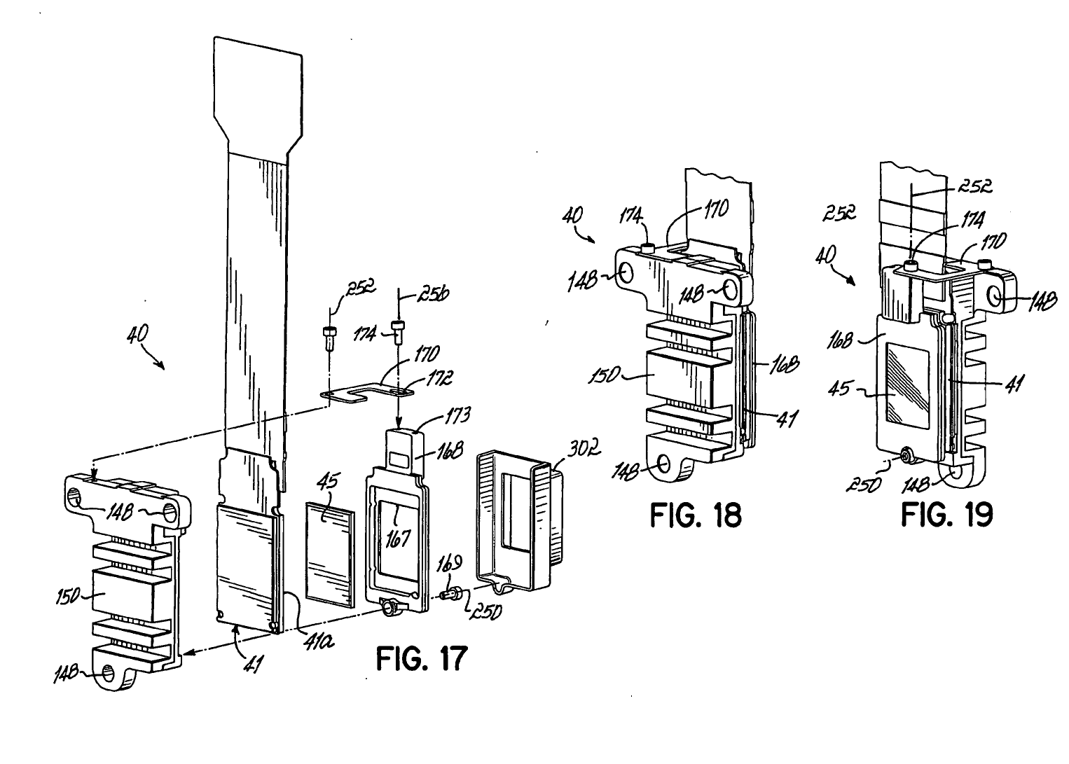

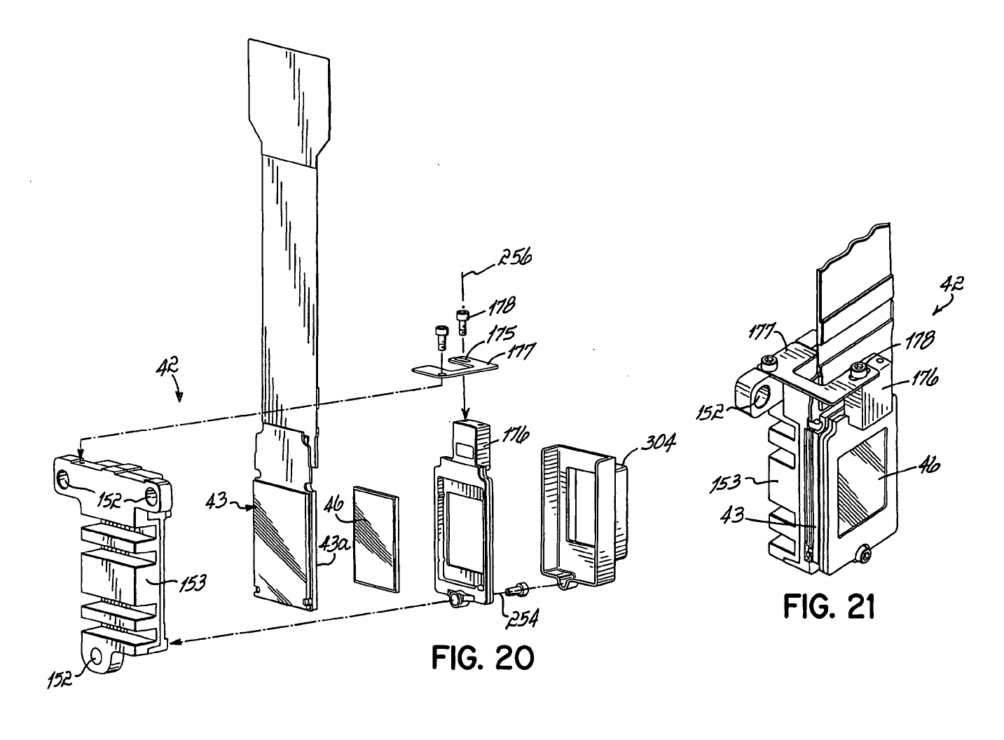

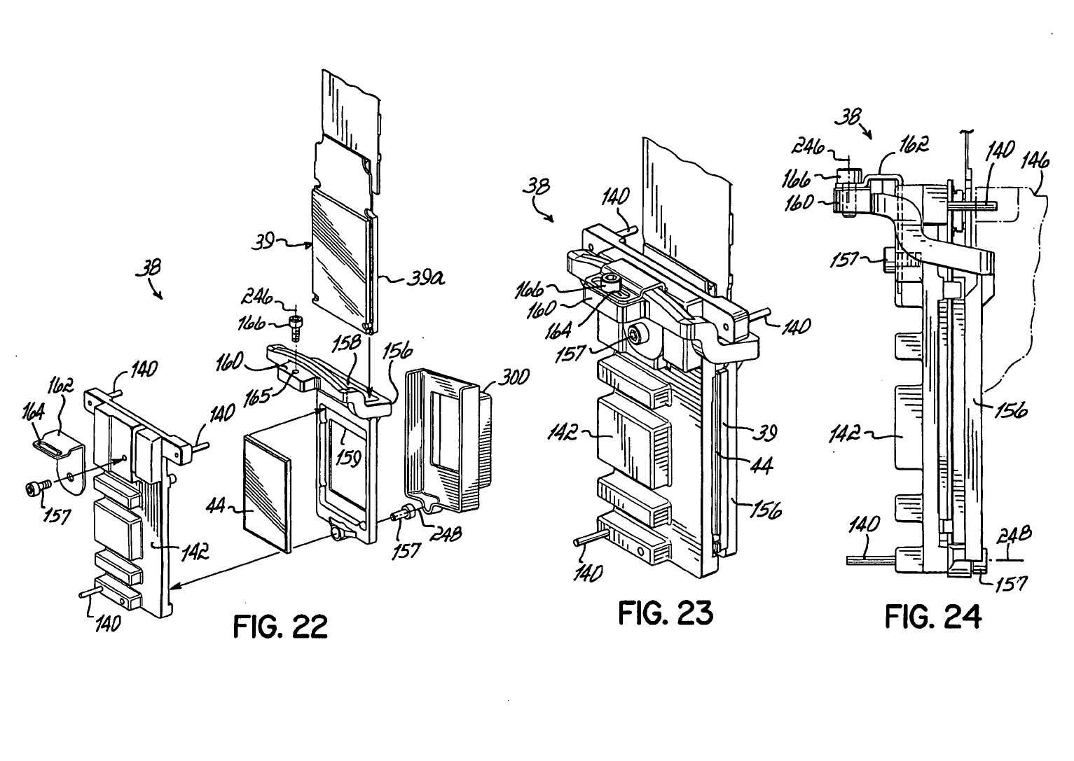

Illumination subsystem 22 includes a light source 26, an ultraviolet filter 28, an optical integrator 30, an optical relay 32 including a plurality of, for example, three relay lenses 98, 99 and 100, a cold mirror 33, a polarizing beamsplitter 34, and an input side of a quad-prism assembly 36. The ultraviolet filter 28, optical integrator 30, optical relay 32, cold mirror 33, and polarizing beamsplitter 34 of illumination subsystem 22 convert a broad spectrum of non-polarized infrared, visible and ultraviolet light emitted by the light source 26 to a uniformly illuminated rectangular area of linearly polarized visible light within a certain cone. The input side of the quad-prism assembly 36 separates the collimated beam of linearly polarized visible light into three distinct primary color components. Each primary color component is characterized by a range of frequencies or wavelengths that is centered about one of the three primary colors—red, green and blue of the electromagnetic spectrum. One beam of light contains photons of green wavelengths between about 510 nm and about 575 nm. The input side 133 of the quad-prism assembly 36 routes the green light to illuminate the rectangular active area or pixel array 39a of a green imager 39 (FIG. 22) incorporated into a green imager assembly 38. Similarly, a second beam contains photons of red wavelengths between about 600 nm and about 700 nm and is routed by the input side of a quad-prism assembly 36 to illuminate the rectangular active area or pixel array 41a of a red imager 41 (FIG. 17) incorporated into a red imager assembly 40. A third beam contains photons of red wavelengths between about 450 nm and about 510 nm. The third beam is routed to illuminate the rectangular active area or pixel array 43a of a blue imager 43 (FIG. 20) incorporated into a blue imager assembly 42.

Key to the operation of the illumination subsystem 22 is the ability to align the optical elements of the illumination subsystem 22 to illuminate the respective rectangular pixel array of each of the imagers 39, 41 and 43 with a beam of linearly polarized primary-color photons having precise dimensions and relative angular orientation and a uniform intensity or brightness. The intensity profile of each beam of light is substantially homogeneous over the two-dimensional, rectangular area and the intensity profiles are substantially uniform among the three beams so that the synthesized full-color image will have a suitable color balance.

With continued reference to FIGS. 1-4 and 10, the projection subsystem 24 includes the output side of the quad-prism assembly 36, the imager assemblies 38, 40 and 42 which include a quarter-wave plate 44 (best shown in FIG. 22-24) filtering green imager 39, a quarter-wave plate 45 (best shown in FIGS. 17-19) filtering red imager 41, and a quarter-wave plate 46 filtering blue imager 43 (best shown in FIG. 20-21), an output polarizer 47, and a projection lens assembly 48. Green imager 39 modulates the incident beam of green light to produce the desired green image component of the full-color image. Red imager 41 modulates the incident beam of red light to produce the desired red image component of the full-color image. Blue imager 43 modulates the incident beam of blue light to produce the desired blue image component of the full-color image.

After each of the image components passes through a respective one of the quarter-wave plates 44, 45 and 46, the image components of primary color are overlapped and synthesized by the output side of the quad-prism assembly 36 to create a full-color image. The full-color image traverses the output polarizer 47 and is projected through the projection lens assembly 48. The projection lens assembly 48 creates the full-color image on the projection screen (not shown) and, thereby, creates a magnified, visible full-color display for viewing. Depending upon the design of the projection screen (not shown) with which light engine 20 is associated, the full-color image can be projected by projection lens assembly 48 to illuminate the front of the projection screen to create a viewable display thereon or to illuminate the rear of the projection screen to create a viewable display on the front thereof.

The operation and interaction of the imagers 39, 41, and 43 and the respective associated one of the quarter-wave plates 44, 45 and 46 is described in U.S. Pat. No. 5,327,270 entitled “Polarizing Beam Splitter Apparatus and Light Valve Image Projection System” issued to Miyatake and assigned to Matsushita Electric Industrial Co., Ltd. (Osaka, Japan). The disclosure of the Miyatake patent is hereby incorporated by reference in its entirety herein.

Key to the operation of the projection subsystem 24 is the ability to align the relative positions and angular orientations of the projection subsystem components so as to precisely overlap the rectangular image components of primary color and, then, accurately direct the combined image components to a specified location on the projection screen with a maximized contrast and an optimized uniform intensity. The pixels of the three primary color images must be precisely registered to produce a high-resolution color image. For example, the light engine 20 can be utilized to generate a stream of full-color images for viewing on a large-area rear projection television.

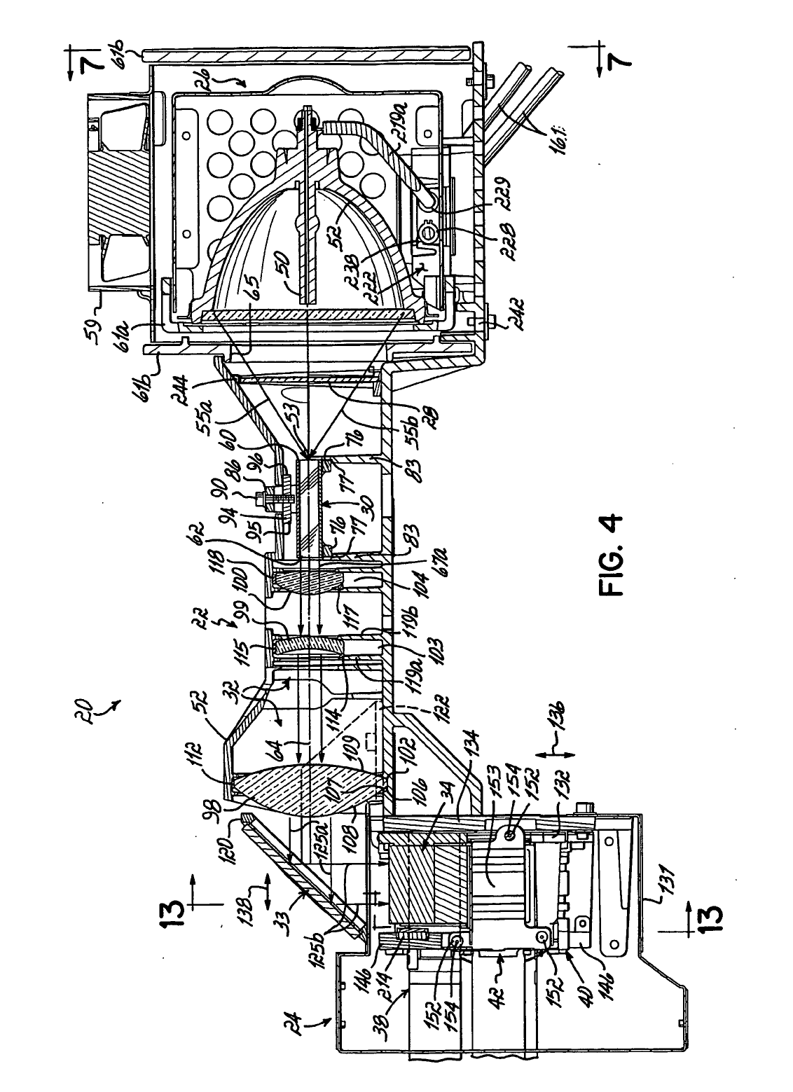

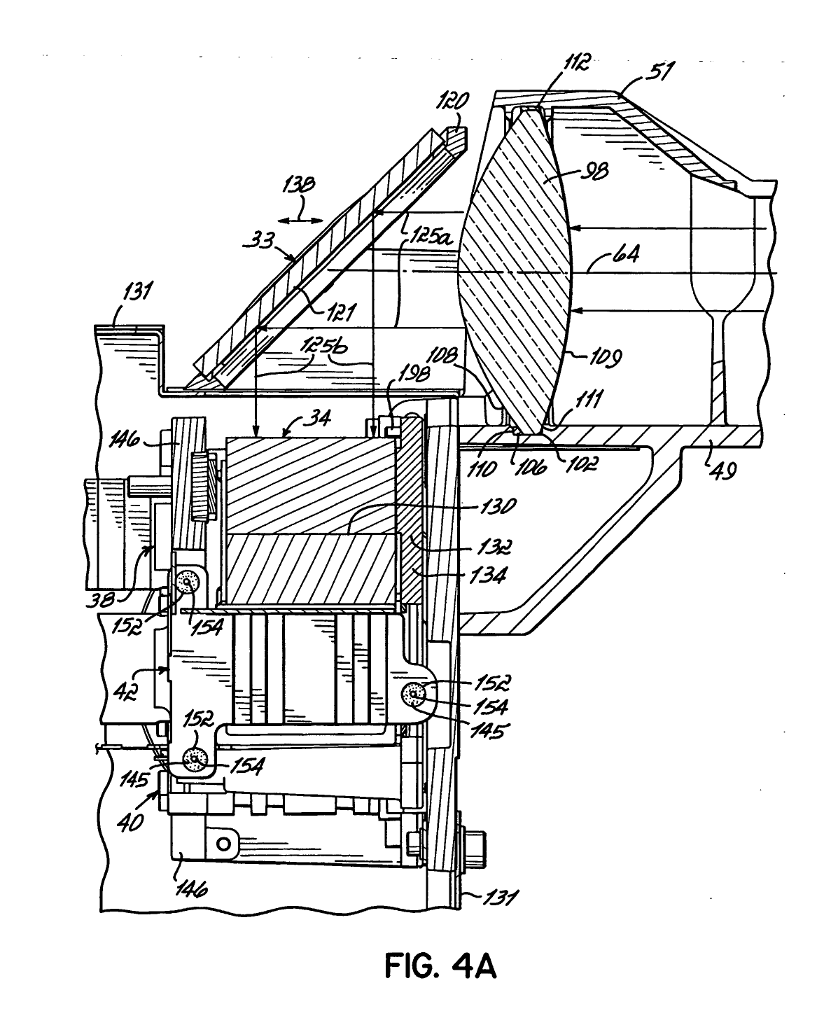

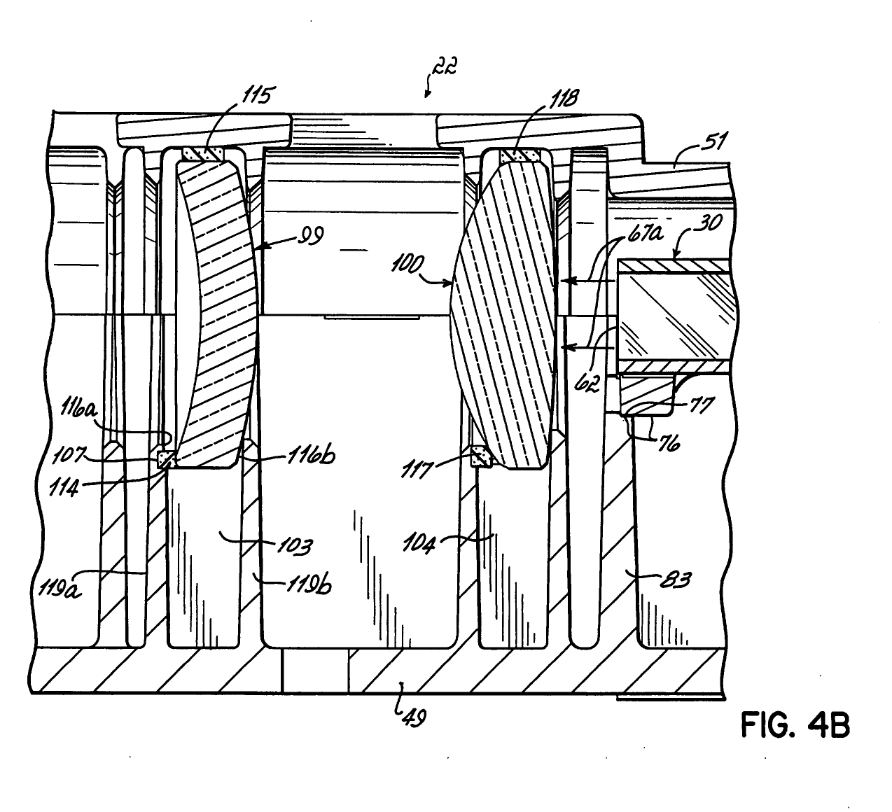

With reference to FIGS. 1-4, a relay chassis 49 carries the light source 26, ultraviolet filter 28, optical integrator 30, optical relay 32, and cold mirror 33. Disposed at one end of the relay chassis 49 is a ventilated rectangular flat platform 242 to which is attached a two-piece outer housing consisting of a first outer housing portion 61a and a second outer housing portion 61b. The platform 242 supports the outer housing portions 61a, 61b and places the light source 26 at an appropriate elevation with respect to the other optical elements held by the relay chassis 49. The light source 26 is removably supported within a generally cubical cavity defined by the walls of the assembled outer housing portions 61a, 61b. A cover 51 is attached to the relay chassis 49 to capture the ultraviolet filter 28, optical integrator 30, and the optical relay 32 therebetween and participates in providing a substantially sealed optical passageway in the illumination subsystem 22. The optical axes of the optical integrator 30 and the optical relay 32 are substantially collinear with an optical axis 64 (FIG. 4) extending from the light source 26 to the cold mirror 33. The relay chassis 49 and cover 51 are preferably fabricated of magnesium, aluminum, zinc, or other strong, lightweight material such as a plastic.

With reference to FIGS. 1-7, the light source 26 includes a burner or lamp 50 (best shown in FIG. 4) partially surrounded by and held near the centerline passing through at least one focal point of an ellipsoidal reflector 52, a mounting flange 54 to which the reflector 52 is attached, and a lamp housing 56 with a removable perforated rear cover 57. Lamp power drive or power supply 58 is electrically cabled to the light source 26 via a two-conductor transmission line 161 to supply electrical power for energizing the lamp 50. The light source 26, when energized by the lamp power supply 58, emanates a high-intensity luminous flux of unpolarized light having wavelengths ranging from about 350 nm to about 800 nm. A discharge bulb such as, for example, a mercury vapor bulb, a metal halide bulb, a xenon bulb, or a halogen bulb is generally used as the lamp 50 of the light source 26. An exemplary lamp suitable for use as lamp 50 is selected from the line of UHP® lamps commercially available from Philips Lighting NV (Eindhoven, Netherlands). The lamp housing 54 may be perforated so that a blower 59 can establish a forced flow of cooling air through the light source 26. The air flow convectively removes and dissipates heat energy generated by the lamp 50 during operation.

A portion of the luminous flux from light source 26 has optical paths directed toward an inlet aperture 60 of the optical integrator 30. Another larger portion of the luminous flux irradiated by light source 26 is reflected by the reflector 52 with optical paths directed toward a focal point 53 of reflector 52. The optical paths of light reflected from reflector 52 toward focal point 53 is indicated diagrammatically by arrows 55a, 55b. The ellipsoidal configuration of the reflector 52 exhibits a pair of focal points, of which focal point 53 is one focal point. When lamp 50 is located at or near one of the other focal points of the ellipsoid as in FIG. 4, an image of the lamp 50 is produced at focal point 53.

The ultraviolet filter 28 is an optical element positioned between the lamp 50 and the inlet aperture 60 of optical integrator 30. Light reflected by the reflector 52 must traverse the ultraviolet filter 28 to enter the integrator 30. The ultraviolet filter 28 removes ultraviolet light having wavelengths of less than about 400 nm from the light rays directed toward inlet aperture 60. Ultraviolet filtering reduces or substantially mitigates degradation of optical bonding materials, such as adhesives, optical cements, or epoxies, used in projection image display system 21.

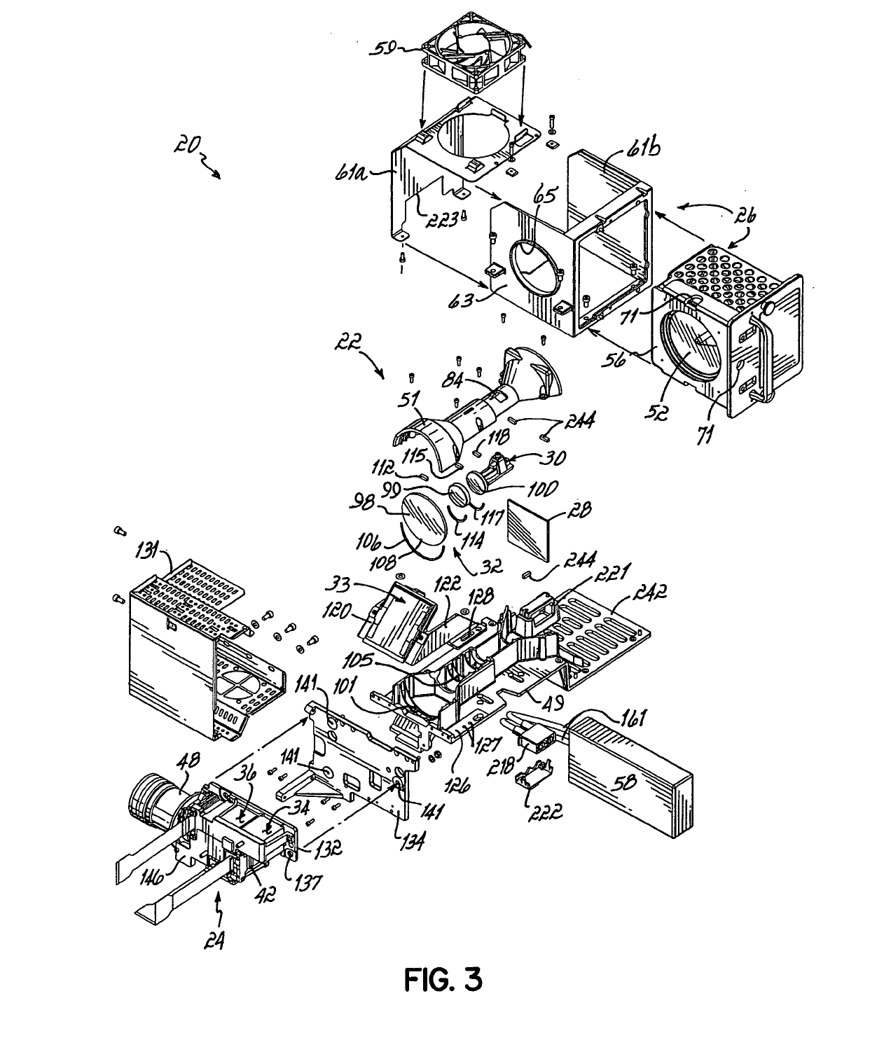

As best shown in FIG. 3, outer housing portion 61b has a rectangular side opening dimensioned and configured for removably inserting the light source 26 into the cavity defined by outer housing portions 61a, 61b. As a result, the entire light source 26 can be simply removed by loosening one or more conventional fasteners and sliding light source 26 from the outer housing portions 61a, 61b with the aid of a handle. One side wall 63 of the outer housing portion 61b is attached to the relay chassis 49 and substantially seals one flared end of the assembled relay chassis 49 and cover 51. A circular opening 65 provided in the side wall 63 is registered with the outer rim of reflector 52 and provides a pathway for the high-intensity luminous flux of unpolarized light from light source 26 to enter the elongated cavity enclosed by the relay chassis 49 and cover 51.

The optical integrator 30, as best shown in FIGS. 4, 8 and 9, includes four elongated rectangular glass plates, each having one longitudinal face coated with a highly-reflective coating. The coated longitudinal faces of the optical integrator 30 are arranged in a rectangular array by attachment of their longitudinal edges so as to form a right parallelepiped and to establish a hollow passageway extending between the inlet aperture 60 and an outlet aperture 62. The optical integrator 30 functions as a waveguide that collects the light arriving from the light source 26 and, through multiple reflections from the coated surfaces inside the integrator 30, mixes the light to produce a substantially uniform or homogenous intensity profile at the outlet aperture 62. The integrator 30 also shapes the incident light to produce a beam of light, exiting from the outlet aperture 62, having a cross-sectional shape that generally matches the shape of the respective active areas 39a, 41a and 43a of the imagers 39, 41, and 43. The cross sectional aspect ratio of the light exiting the outlet aperture 62 is essentially equal to the aspect ratio of the respective active areas 39a, 41a and 43a of the imagers 39, 41, and 43.

The inlet aperture 60 of the optical integrator 30 is a rectangular planar opening which is substantially centered on the optical axis 64. The mounting flange 54 holding the reflector 52 is positioned axially relative to the inlet aperture 60 to locate the focal point 53 of reflector 52 in the vertical plane defined by the inlet aperture 60. The axial position of the light source 26 parallel to the optical axis 64 may be reproducibly established by guides (not shown) on one or both of the outer housing portions 61a, 61b.

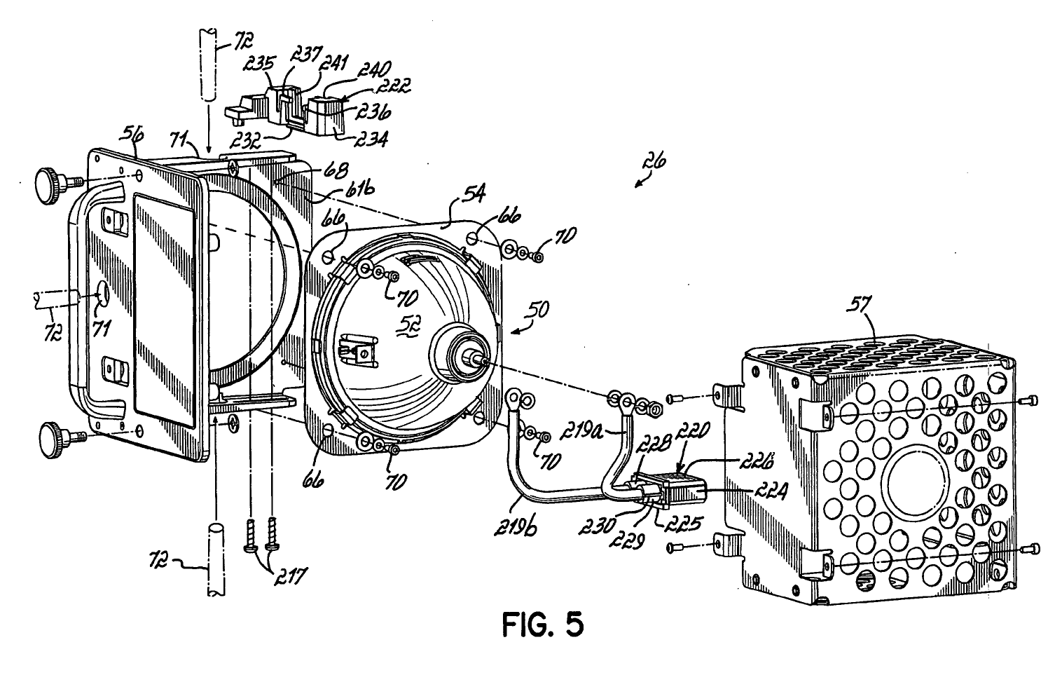

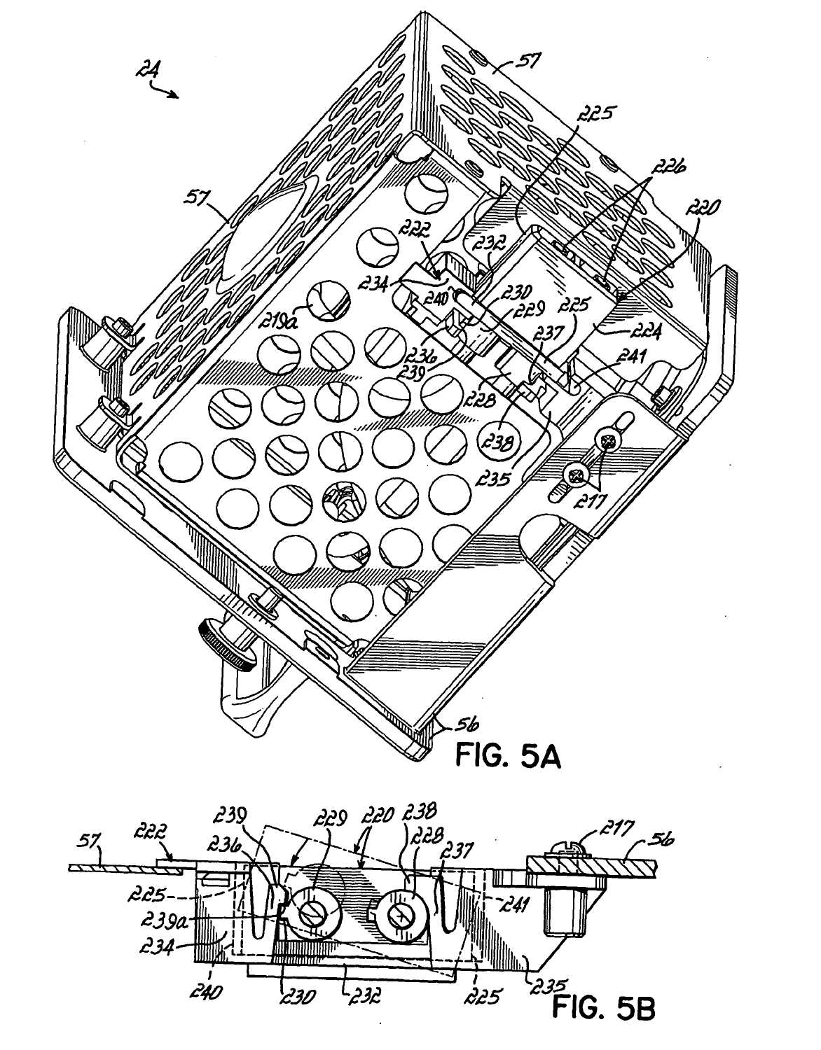

According to one aspect of the present invention and with reference to FIGS. 5, 5A, 6 and 7, the mounting flange 54 of the light source 26 is positionable in a plane substantially perpendicular to the optical axis 64 so that the focal point of reflector 52 can be made to coincide accurately with the center of the plane defined by the inlet aperture 60. Typically, the positional accuracy is less than about 0.2 mm. A plurality of, for example, four mounting openings 66 are located about the circumference of the mounting flange 54. As best illustrated in FIG. 5, one of the mounting openings 66 is located at each corner of the mounting flange 54 but the present invention is not so limited. An inside surface of the lamp housing 56 is provided with a plurality of tapped holes 68 (FIG. 5) positioned in an array that correlates with the positions of the mounting openings 66. Preferably, each complementary pair of mounting openings 66 and tapped holes 68 is substantially concentric when assembled. A threaded fastener 70 is inserted into each mounting opening 66 and threadingly received within the respective one of the tapped holes 68. The threaded fasteners 70 are tightened by applying a tightening torque with an appropriate conventional tool to secure the mounting flange 54 to the lamp housing 56.

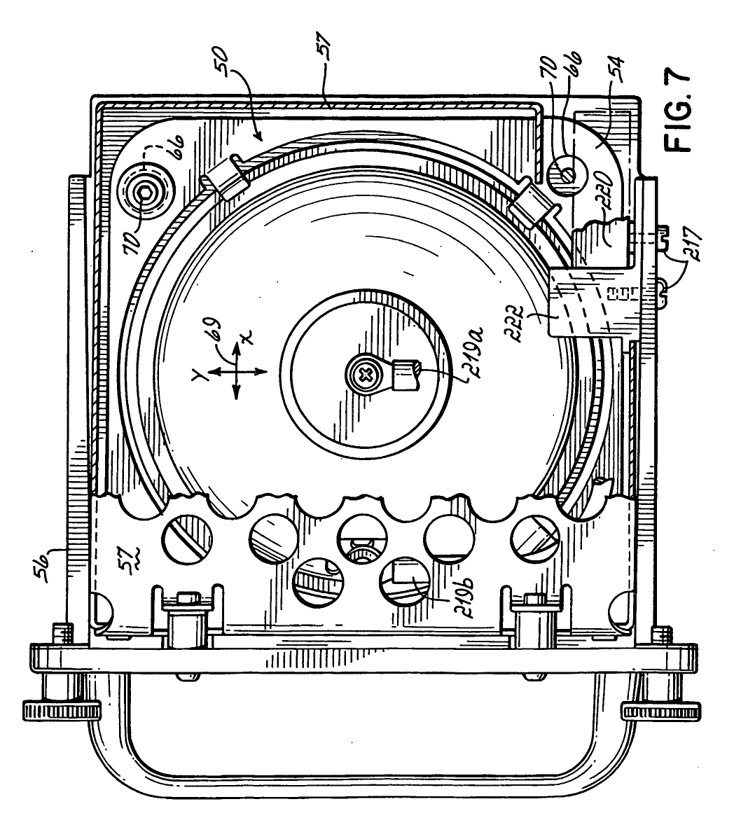

As best shown in FIG. 7, the diametrical dimension of each threaded fastener 70 is less than the diametrical dimension of its respective mounting opening 66 so that, in an unsecured condition, the mounting flange 54 is movable relative to the lamp housing 56. Specifically, the mounting flange 54 is movable laterally within a two-dimensional x-y coordinate frame 69 relative to the lamp housing 56. The lateral movement is used to laterally align the focal point 53 of the reflector 52 with the position in the plane defined by the inlet aperture 60, which may be the geometrical center of the plane so defined, that optimizes the intensity or brightness of the homogeneous, beam of light, indicated diagrammatically in FIG. 4 by the arrows labeled with reference numeral 67a that is exiting the integrator 30.

To align the reflector 52 of the light source 26, the removable perforated rear cover 57 is detached from the lamp housing 56 to provide access to the threaded fasteners 70. Multiple probes of an alignment fixture 72, attached to individual micromanipulators (not shown) capable of precision movement, are extended through openings 71 in the lamp housing 56 to contact the non-reflecting side of reflector 52 at spaced apart locations about its periphery. The threaded fasteners 70 are loosened to permit the mounting flange 54 to move laterally relative to the lamp housing 56. Threaded fasteners 70, when loosened, act as mounting posts that constrain the range of lateral movement in the x-y coordinate frame 69. The alignment fixture 72 adjusts the position of the mounting flange 54 relative to the x-y coordinate frame 69 while monitoring the intensity of the beam of light 67a exiting the outlet aperture 62 of the integrator 30. After the intensity of the beam of light 67a is optimized, the threaded fasteners 70 are tightened to secure the mounting flange 54 and the alignment fixture 72 is withdrawn.

It is understood by those of ordinary skill in the art that the alignment of the mounting flange 54 carrying reflector 52 with respect to the lamp housing 56 may be performed on a test stand while monitoring the intensity of the light with a device such as a light detector. Thereafter, the light source 26 is installed as a prealigned unit into the cavity defined by outer housing portions 61a, 61b.

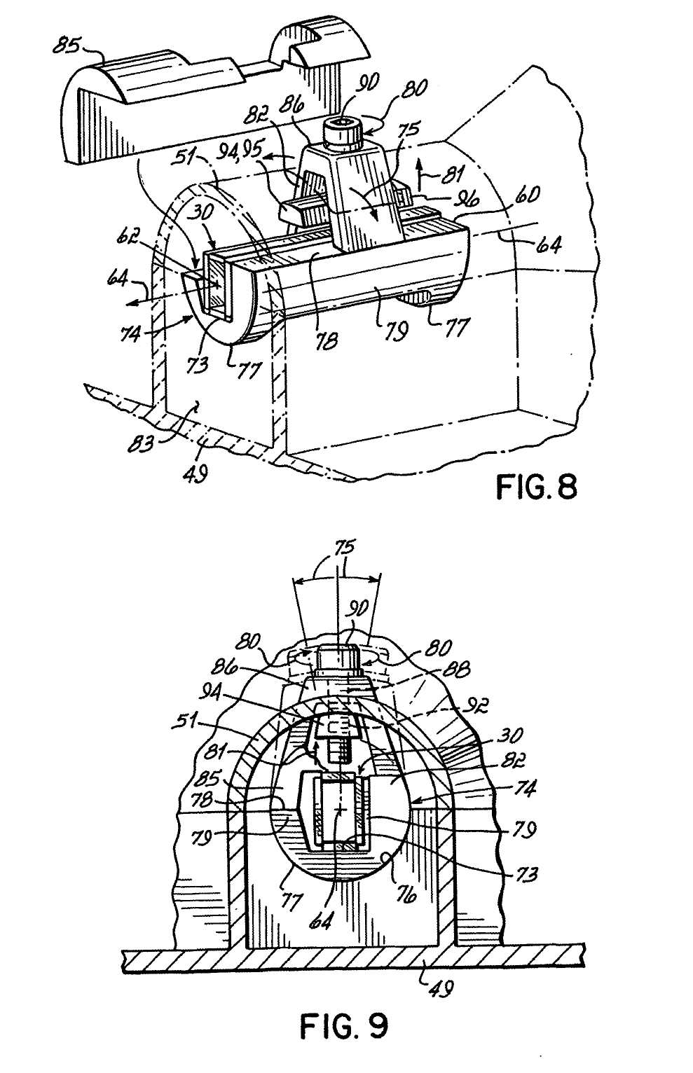

With reference to FIGS. 1-4, 8 and 9, the optical integrator 30 is supported by a pair of spaced substantially planar longitudinally spaced support surfaces, of which one support surface 73 is shown, and located between the inner surfaces of two opposed side walls 79 of an integrator tilt cradle 74. One outer surface of optical integrator 30 is affixed, such as by an adhesive, optical cement, or epoxy, to one of the side walls 79. The optical integrator 30 is positioned between the light source 26 and the optical relay 32 with the longitudinal axis of the integrator tilt cradle 74 aligned substantially parallel to the optical axis 64. The relay chassis 49 has a pair of spaced upwardly-facing concave or arcuate upper bearing surfaces 76 formed along a selected radius. Each upper bearing surface 76 is located on a respective flange 83 that extends upwardly from the base of the relay chassis 49. The integrator tilt cradle 74 has a pair of spaced convex or arcuate bottom bearing surfaces 77 configured and positioned to contact the upper bearing surfaces 76 of the relay chassis 49. Bearing surfaces 77 are formed along a selected radius and are complementary in shape with that of the upper bearing surfaces 76 of relay chassis 49. Integrator tilt cradle 74 is pivotal on the upper bearing surfaces 76, as indicated by arrows 75, through a selected range of tilt angles from the vertical and, in a selected embodiment, the angular orientation of the integrator tilt cradle 74 is variable over an angular range of about +5° to about −5° with respect to vertical. The angular range through which the integrator tilt cradle 74 may be tilted is exaggerated in FIGS. 8 and 9 for purposes of illustration.

A spaced-apart pair of inclined posts 82 extend upwardly and inwardly from near the center of the integrator tilt cradle 74. Each inclined post 82 is attached to one of a pair of parallel spaced top edge portions 78 of the side walls 79. The inclined posts 82 protrude through an opening 84 provided in the cover 51. The opening 84 has a width or transverse dimension, in a direction transverse to the longitudinal axis of the integrator tilt cradle 74, sufficient to permit the integrator tilt cradle 74 to be tilted or pivoted through a small angular arc limited by the contact of one of the inclined posts 82 with the transverse edges of the opening 84. Applying a tilting force causes the bottom bearing surfaces 77 of integrator tilt cradle 74 to slidingly rotate with respect to, against and within the upper bearing surfaces 76 of the relay chassis 49. The pivoting of the integrator tilt cradle 74 rotates the optical integrator 30 about the optical axis 64, which has the effect of rotating the beam of light exiting from the outlet aperture 62. The angular adjustment of the beam of light exiting from the outlet aperture 62 is used to align the angular orientation of the green, red and blue light beams to correspond with the angular orientation of the respective imagers 39, 41, and 43 and thereby correct for rotational misalignment of the illumination subsystem 22, as will be discussed below.

With continued reference to FIGS. 1-4, 8 and 9, the inclined posts 82 are joined at their apex by a horizontal top wall 86. A vertical throughhole 88 is provided in a central area of the top wall 86 that is dimensioned to receive a threaded fastener 90. The threaded fastener 90 extends a distance below the bottom of the top wall 86 to enable a locking bar 94 of substantially rectangular shape to be threaded thereon. The threaded fastener 90 threads into a tapped hole 92 provided near the center of the locking bar 94. The locking bar 94 is positioned between the top wall 86 and the optical integrator 30. The locking bar 94 has a longitudinal dimension that is greater than a longitudinal dimension of the opening 84 in the cover 51. The threaded fastener 90 and locking bar 94 are operable to releasably secure or clamp the angular orientation of the integrator tilt cradle 74 with respect to the relay chassis 49 at one of a selected range of tilt angles between the opposite longitudinal sides of opening 84. A tilt cradle cover 85 encloses the upper portion of the integrator tilt cradle 74 and is provided with an opening shaped and sized to permit unobstructed vertical movement of locking bar 94 relative to the top wall 86.

In use, a torque is applied in a direction as indicated generally by arrow 80 (FIG. 9) that advances the tip of the threaded fastener 90 toward the optical integrator 30. The locking bar 94 cannot rotate due the physical constraint afforded by contact of its inclined sides with inclined portions of the confronting inclined inner surfaces of the inclined posts 82. As a result, the locking bar 94 moves toward the top wall 86 in the direction of arrow 81 as the threaded fastener 90 is turned in the direction of arrow 80 to tighten the fastener 90. As the threaded fastener 90 is progressively tightened, a front portion 95 of the locking bar 94 contacts a first portion of the cover 51 adjacent to one transverse side of opening 84 and a rear portion 96 of the locking bar 94 contacts a second portion of the cover 51 adjacent to the opposite transverse side of opening 84. The front and rear portions 95, 96 collectively transfer a securement force from the threaded fastener 90 to the cover 51 that secures, in a locked condition, the integrator tilt cradle 74 and the optical integrator 30 against pivoting. In accordance with one aspect of the present invention, the locking bar 94 permits the securement force to be applied without inducing extraneous pivotal movement of integrator tilt cradle 74 from a desired angularly aligned orientation.

With reference to FIGS. 3, 4, 4A and 4B, the plurality of three relay lenses 98, 99 and 100 forming the optical relay 32 are positioned between the outlet aperture 62 of the optical integrator 30 and the cold mirror 33. Relay lenses 98, 99 and 100 create an image of the light beam exiting the outlet aperture 62 of the optical integrator 30 which is reflected by the cold mirror 33 to the imagers 39, 41 and 43. The relay lenses 98, 99 and 100 are formed of a material such as, but not limited to, an optical glass or an acrylic polymer. Relay lens 98 is positioned in a curved recess 102 provided in the base of the relay chassis 49. Similarly, relay lens 99 is positioned in a curved recess 103 provided in the base of the relay chassis 49 and relay lens 100 is positioned in a curved recess 104 provided in the base of the relay chassis 49. The recesses 102, 103 and 104 are dimensioned and configured to align the optical axes of the relay lenses 98, 99 and 100 and to maintain the relay lenses 98, 99 and 100 in proper relationship. Relay lens 98 also seals one end of the assembled relay chassis 49 and cover 51 against the entry of dust and other particulate matter.

According to one aspect of the present invention and with continued reference to FIGS. 3, 4, 4A and 4B, a insert 106 is dimensioned and configured to be inserted along with relay lens 98 into the recess 102 (FIGS. 3-4A) and may be semicircular and annular. The insert 106 is adhered to a narrow annular ring extending about the peripheral rim of one face 108 of the relay lens 98. The insert 106 is formed of a resilient or pliable material, such as a foam rubber. The relay chassis 49 has a pair of spaced confronting concave or arcuate mounting surfaces 110, 111 formed along a selected radius. The curvature of each of the mounting surfaces 110, 111 is similar to the curvature of relay lens 98. The mounting surfaces 110, 111 are located on a respective side of the recess 102 and extend upwardly from the base of the relay chassis 49 to bound boundaries for recess 102. A pair of ribs 101 (FIG. 3) longitudinally bridge the recess 102 and provide vertical support surfaces for a bottom portion of the peripheral edge of lens 98.

As the relay lens 98 and the insert 106 are vertically inserted into the recess 102, the insert 106 is resiliently captured between the lens 98 and an arcuate shoulder formed by mounting surface 110. The resilient capture compresses the insert 106 and, thereby, urges the relay lens 98 rearwardly to abut and contact the mounting surface 111 of the recess 102. The mounting surface 111 serves as a reference surface for the securement and alignment of lens 98. The cover 51 is provided with a curved pad 112 of a substantially rectangular cross-section, also formed of a resilient or pliable material, which is positioned and configured to compressively engage a flat side edge portion along the upper rim of the relay lens 98, when the cover 51 is attached to the relay chassis 49. The insert 106 and the pad 112 cooperate to provide a passive restraint for relay lens 98 and to ensure proper positioning of lens 98 in the optical relay 32.

With continued reference to FIGS. 3, 4, 4A and 4B and similar to the previous description of the mounting of relay lens 98, an insert 114 is dimensioned and configured to be inserted along with relay lens 99 into the recess 103. Insert 114 may be semicircular and annular. In certain embodiments, the insert 114 is adhered with an adhesive, optical cement, or epoxy to a narrow annular ring extending about the peripheral rim of one face of the relay lens 99. The insert 114 is formed of a resilient or pliable material, such as a foam rubber. The relay chassis 49 has a pair of spaced confronting concave or arcuate mounting surfaces 116a, 116b formed along a selected radius. Each mounting surface 116a, 116b is located on a respective one of a spaced apart pair of flanges 119a, 119b that are substantially parallel and that extend upwardly away from the base of the relay chassis 49. Flange 119a has a slightly smaller vertical dimension than flange 119b. Recess 103 is bounded by the flanges 119a, 119b. The curvature of each of the mounting surfaces 116a, 116b is similar to the curvature of relay lens 99. A pair of ribs 105 (FIG. 3) extend between the flanges 119a, 119b to bridge the recess 103 and provide vertical support surfaces for a bottom peripheral edge of the lens 99.

As the relay lens 99 and the insert 114 are inserted into the recess 103, the insert 114 is resiliently captured between the lens 99 and a curved or arcuate ledge 107 formed on one side of recess 103. The resilient capture compresses the insert 114 and thereby urges the relay lens 99 rearwardly to abut and contact the mounting surface 116b of the recess 103. The mounting surface 116b serves as a reference surface for the securement and alignment of lens 99. The cover 51 is provided with a pad 115, also formed of a resilient or pliable material. When the cover 51 is attached to the relay chassis 49, the pad 115 is positioned and configured to compressively engage a flat side edge portion along the upper rim of the relay lens 99. The insert 114 and the pad 115 cooperate to provide a passive restraint for relay lens 99 and to ensure proper positioning of relay lens 99 in the optical relay 32. Similarly, an insert 117 and a pad 118, similar to insert 114 and pad 115, are provided to restrain and position relay lens 100. The ultraviolet filter 28 is held in position in the relay chassis 49 by a set of rectangular resilient pads 244 similar to pads 112, 115 and 118.

With reference to FIGS. 1-4 and 4A, a moveable inclined frame 120 is moveably attached to the opposite flared end of the relay chassis 49 and holds the cold mirror 33 in a position suspended vertically above the polarizing beamsplitter 34. Inclined frame 120 locates the cold mirror 33 in a position that intercepts the beam of incident light, diagrammatically indicated by arrows 125a in FIG. 4A, exiting relay lens 98. The beam of incident light 125a emerges from relay lens 98 with an optical path substantially parallel to optical axis 64. The cold mirror 33 has a reflective surface 121 that reduces or eliminates infrared light from the beam of incident light 125a exiting from relay lens 98 by reflecting light in the visible portion of the electromagnetic spectrum between wavelengths of about 400 nm and about 700 nm and transmitting light having infrared wavelengths greater than about 700 nm. The transmitted infrared light is discarded for reducing or substantially mitigating detrimental thermal effects from the luminous flux output by light source 26.

The inclined frame 120 supports the cold mirror 33 at an inclined angle of about 45° relative to the optical axis 64 and reflects photons having the visible wavelengths in the beam of light to provide a beam of reflected light, indicated diagrammatically by arrows 125b in FIG. 4A, traveling toward the polarizing beamsplitter 34. A pair of parallel, spaced-apart arms 122, of which one arm 122 is visible in the figures, extend from a lower surface of the inclined frame 120 in a direction substantially parallel to the optical axis 64 and toward the relay lens 98. The inclined frame 120 is moveable relative to the relay chassis 49 in a z-direction substantially parallel to the optical axis 64, and indicated in FIGS. 4, 14 and 16 by double-headed arrow 138, to increase or decrease the spacing between cold mirror 33 and relay lens 98. To that end, each arm 122 has an outwardly-extending flange 124 that contacts one of a pair of flat mounting surfaces 126 (best shown in FIG. 3) correspondingly located on the base of the relay chassis 49. Each flange 124 has an elongate slot 128 (best shown in FIG. 3) with a major axis oriented parallel to the optical axis 64. One or more fasteners 129 are insertable into each of the elongate slots 128 and threadingly fastened to a corresponding number of threaded holes 127 provided in each mounting surface 126. The axial movement of the cold mirror 33 is constrained by contact between the fasteners 129 and the opposite inner peripheral edges along the major axis of each respective slot 128. The engagement between slots 128 and threaded fasteners 129 also limits the rotation of the inclined frame 120 during axial movement.

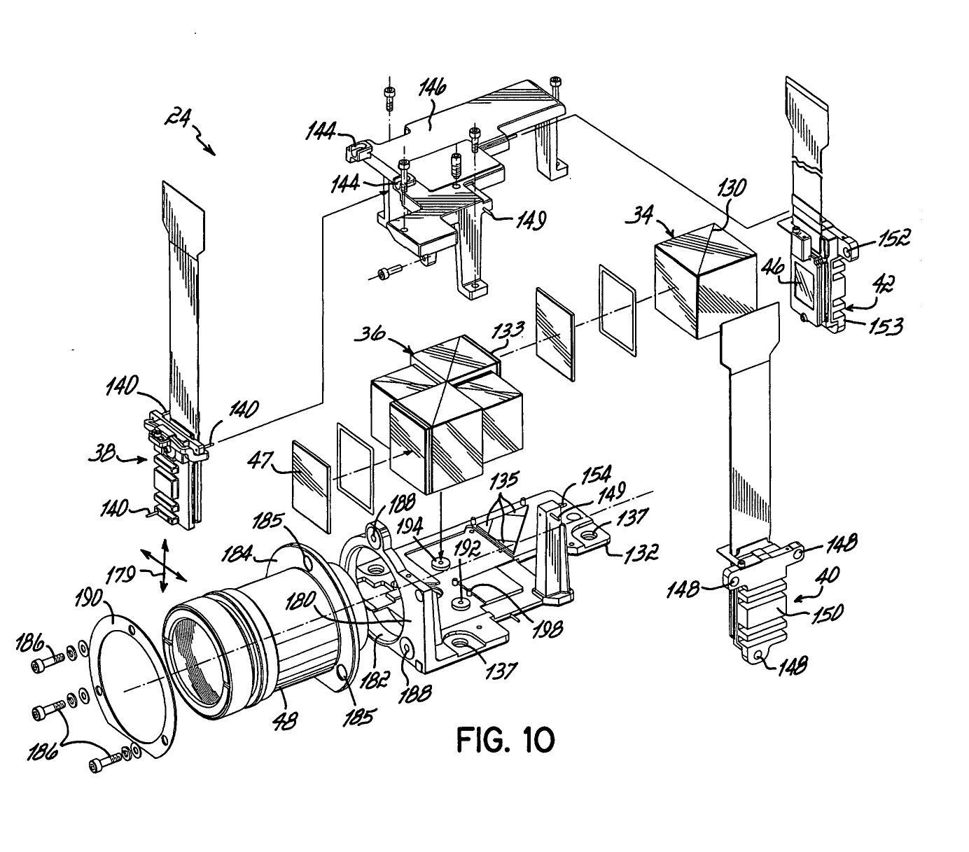

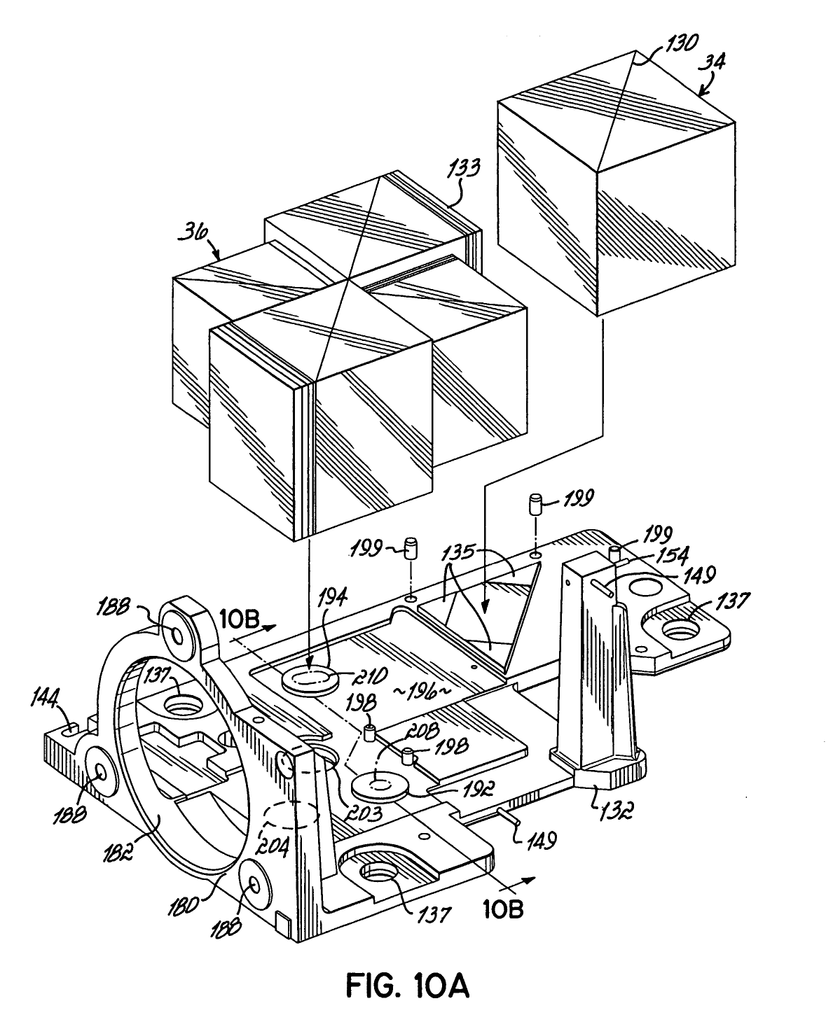

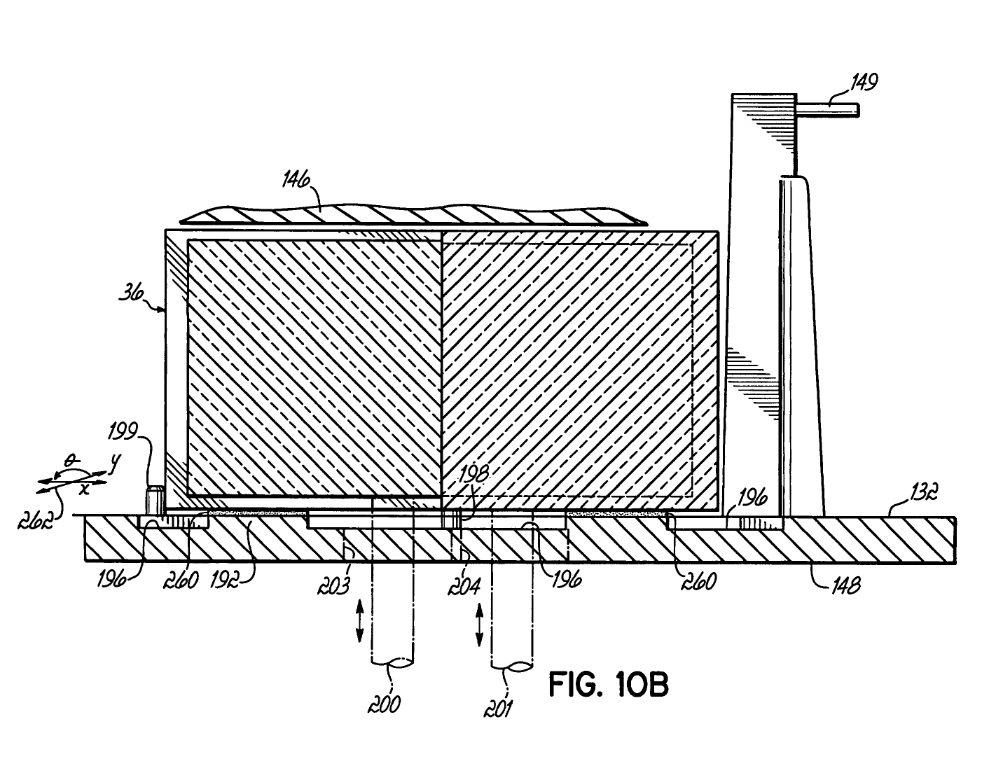

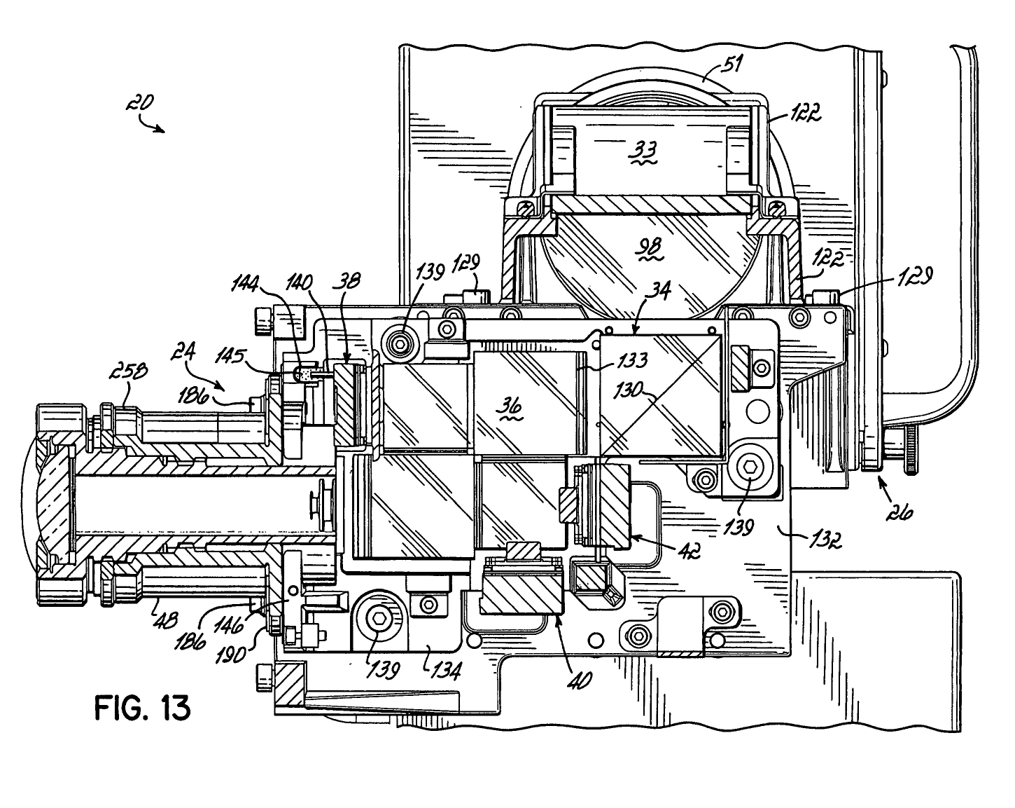

With reference to FIGS. 1-4, 10, 10A and 10B, the polarizing beamsplitter 34, the quad-prism assembly 36, the imager assemblies 38, 40 and 42, the output polarizer 47, and the projection lens assembly 48 are mounted as an assembly to a mounting plate 132, which may be formed from aluminum. The mounting plate 132 is moveably attached to a bracket 134, which is affixed by conventional fasteners or the like in a stationary manner to a side edge of the relay chassis 49. Arranged about the periphery of the mounting plate 132 are a plurality of, for example, three oversized holes 137 (FIGS. 3, 10 and 10A) that receive the respective shafts of a corresponding number of threaded fasteners 139 (FIGS. 4 and 13) which are threadingly fastened to complementary tapped holes 141 (FIG. 3). The mounting plate 132 and the attached collection of optical elements are partially surrounded by a perforated shroud 131 that shields against electromagnetic interference.

With particular reference to FIGS. 10 and 10A, the polarizing beamsplitter 34 is mounted with adhesive to three raised triangular pads 135 on the mounting plate 132 and positioned adjacent to the entrance face 133 of the quad-prism assembly 36. Polarizing beamsplitter 34 is an optical device that divides a beam of light into two separate beams. Polarizing beamsplitter 34 consists of two right-angle prisms cemented together at their hypotenuse faces. The cemented face of one of the pair of prisms is coated, before cementing, with a dielectric layer having the desired reflecting properties. In particular, the coating used in polarizing beamsplitter 34 provides a beam-splitting interface 130 that separates s-polarized light rays from p-polarized light rays in the beam of light reflected from the cold mirror 33.

With reference to FIGS. 4A, 14 and 15, the beam-splitting interface 130 is operable to divide unpolarized light into p-polarized light and s-polarized light. The beam of p-polarized light passes unaltered through the beam-splitting interface 130 and is discarded. The direction of propagation of the beam of s-polarized light is changed by the beam-splitting interface 130. Specifically, the beam of s-polarized light is reflected toward the entrance face 133 of the quad-prism assembly 36. The polarizing beamsplitter 34 has the geometrical shape of a parallelepiped bounded by six parallelograms and typically a cube. The beam splitting interface 130 defines a plane inclined to intersect the center of the polarizing beamsplitter 34 and two opposite edges thereof. The beam splitting interface 130 confronts and is inclined generally parallel with the reflective surface 121 of the cold mirror 33.

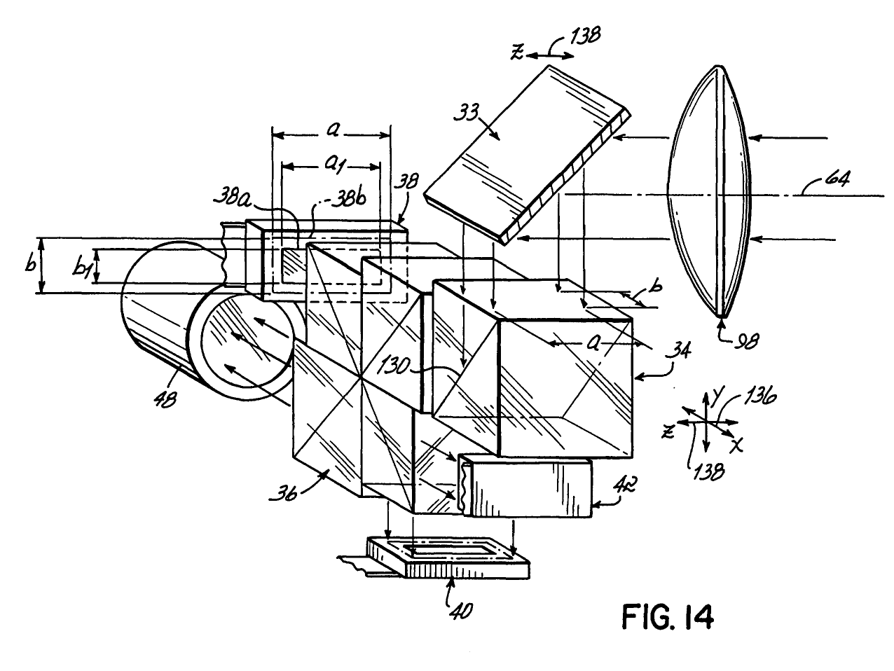

As diagrammatically illustrated in FIG. 14, the beam of visible light reflected from the cold mirror 33 has a long or major axis, a, aligned substantially parallel to the z-direction 138 and a short or minor axis, b, oriented substantially parallel to the x-direction of a coordinate frame 136. When the cold mirror 33 is moved substantially parallel to the optical axis 64, the major axis of the beam of light reflected by mirror 33 translates transversely with respect to the inclined plane of the beam splitting interface 130. Axial movement of the cold mirror 33 alone preferably does not move the minor axis of the beam parallel to the inclined plane of the beam splitting interface 130.

The s-polarized beam of visible light from the polarizing beamsplitter 34 is separated into the three components of primary color (red, blue, green) by passage through the input side of the quad-prism assembly 36, as understood by those of ordinary skill in the art. The quad-prism assembly 36 is a conventional preassembled assembly of optical elements, including four rectangular prisms and various polarization filters, mounted to a portion of a mounting plate 132. The four prisms of the quad-prism assembly 36 have rectangular surfaces bonded to rectangular surfaces of adjacent prisms and are arranged in a square planar array. As understood by those of ordinary skill in the art, the quad-prism assembly 36 uses polarization filters that selectively alter the relative polarization of the primary color components and polarizing beamsplitters to separate the primary color components and recombine the modulated primary color components to create a full-color image for display on a projection screen.

An exemplary device suitable for use as quad-prism assembly 36 is manufactured by ColorLink Inc. (Boulder, Colo.) under the trade name Color Quad®. Such a quad-prism assembly is disclosed in U.S. Pat. No. 6,183,091 entitled “Color Imaging Systems and Methods” issued to Johnson et al. and assigned to Colorlink Inc. (Boulder, Colo.). The disclosure of the Johnson et al. patent is hereby incorporated by reference in its entirety herein.

As discussed above, the rectangular pixel array 39a, 41a and 43a of each of the imagers 39, 41 and 43, respectively, is arranged in a large number of rows and columns. The pixels of each of the pixel arrays 39a, 41a and 43a are adapted to display a sequence of binary images as frames of a multi-image display, provided over a respective flexible ribbon cable from an electronic image source. The image source includes control, memory and drive circuits required to service individual pixels as understood by those of ordinary skill in the art. When illuminated with light, each binary image is transferred from pixel arrays 39a, 41a and 43a to the respective one of the three beams of green, red and blue light and the modulated light is reflected. To modulate the incident luminous flux and transfer the respective primary-color image component, the individual pixels of each pixel array 39a, 41a and 43a reflect or absorb photons depending on the binary state. The rectangular pixel array 39a, 41a and 43a of each of the imagers 39, 41 and 43 has a long or major axis of pixel columns, a short or minor axis oriented perpendicular to the minor axis of pixel rows, and an aspect ratio which represents the ratio of the length of the major axis to the length of the minor axis.

Imagers 39, 41 and 43 may be, for example, conventional liquid crystal on silicon (LCOS) microdisplays or spatial light modulators (SLM's) having, for example, between one and two megapixels in their pixel arrays 39a, 41a and 43a and a pixel pitch of about 10 to 15 μm. The LCOS microdisplays selectively modulate the polarization orientation of the reflected light. The polarization change imparted by such LCOS microdisplays is used to control the direction of progression of the primary color components through the output side of the quad-prism assembly 36.

An LCOS microdisplay suitable for use in the present invention as each of imagers 39, 41 and 43 is commercially available from Three-Five Systems, Inc. (Tempe, Ariz.) under the tradename MD1280. Details of the MD1280 LCOS microdisplay are disclosed in “MD1280 Microdisplay Product Specification: Rev. J,” published by Three-Five Systems, Inc. on Oct. 2, 2000, which is hereby incorporated by reference in its entirety herein.

With reference to FIGS. 14-16, the mounting plate 132 is movable relative to bracket 134 in a plane coplanar with a two-dimensional coordinate frame. The polarizing beamsplitter 34, the quad-prism assembly 36, the imager assemblies 38, 40, and 41, the output polarizer 47, and the projection lens assembly 48 are attached to the mounting plate 132 and moveable therewith as a unitary assembly. The movement of the mounting plate 132 is utilized to align the beams of primary color light with the rectangular pixel arrays 39a, 41a and 43a of the respective one of imagers 39, 41, and 43.

With continued reference to FIGS. 14-16, the beam of light redirected by the beam-splitting interface 130 of the polarizing beamsplitter 34 is divided into three beams of primary color light by the input side of the quad-prism assembly 36. The three beams of primary color light are routed to the appropriate one of the imagers 39, 41 and 43 of imager assemblies 38, 40 and 42, respectively. The area of each beam of primary color light preferably overlaps the respective pixel array 39a, 41a and 43a of the appropriate one of the imagers 39, 41 and 43. A given amount of overscan is required to concurrently overlap the three beams of primary color light with each of the three imagers 39, 41 and 43. For example, the overscanning of the luminous flux is diagrammatically illustrated on FIG. 14 for the green imager 39 by the difference in area of the dashed-line rectangle 38a, representing the rectangular dimensions of the beam of green light, and the active imaging area of the green imager 38, represented by the full-line rectangle 38b. The present invention minimizes the amount of overscanning required to approximately 5 percent so that the light originating from light source 26 is efficiently used in illumination subsystem 22 compared with conventional illumination subsystems that overscan by 10 percent or more to ensure adequate light coverage for multiple imagers.

Each of the beams of primary color light redirected by the polarizing beamsplitter 34 and separated by the input side of the quad-prism assembly 36, in route to the appropriate one of the imagers 39, 41 and 43, has a major axis that is rotated by 90° relative to, and oriented substantially parallel to, the major axis of the beam of light reflected by cold mirror 33. Similarly, each of the beams of primary color light has a short or minor axis, b, oriented substantially parallel to the y-direction of the coordinate frame 136 (FIG. 14) and perpendicular to the major axis. An aspect ratio may be defined as a ratio of the major axis to the minor axis for each of the beams of primary color light.

With reference to FIG. 14, the major axis of each of the beams of primary color light is preferably aligned substantially parallel to the major axis, a₁, of the appropriate one of the imagers 39, 41 and 43. Likewise, the minor axis of the beam of light reflected by the beam-splitting interface 130 is preferably aligned substantially parallel to the minor axis, b₁, of the appropriate one of the imagers 39, 41 and 43. The output side of the quad-prism assembly 36 recombines and synthesizes the beams of primary color light after each has been modulated by the appropriate one of the imagers 39, 41 and 43 and supplies the three primary color images in an overlapping, color-converged manner to provide a high-resolution full-color image that is projected by projection lens assembly 48 onto the front or the rear of a projection screen.

In use and with reference to FIGS. 1-4, 8, 9 and 14-16, the alignment features of the assembled illumination subsystem 22 permit the illumination subsystem 22 to be aligned and oriented such that the beams of primary color light illuminate the appropriate one of the imagers 39, 41 and 43 with an adequate coverage and an adequate flux intensity. One of the imagers, for example, green imager 39, is selected for monitoring the properties or attributes of the luminous flux output by the illumination subsystem 22. While monitoring the beam of green light at green imager 39, the mounting flange 54 holding the reflector 52 is positioned in a plane parallel to the plane of the inlet aperture 60 to optimize the intensity, as discussed above. While monitoring the angular alignment of the beam of green light with the green imager 39, the cradle 74 is pivoted to rotate the optical integrator 30 about the optical axis 64. When the desired angular orientation of the optical integrator 30 is achieved to align, for example, the major axis of the green imager 39 with the major axis of the beam of green light, the threaded fastener 90 is tightened to secure nut 94 against the cover 51 and, thereby, to prevent extraneous angular movement of the optical integrator 30.

Next, the beam of green light is overlapped with the rectangular pixel array 39a of the green imager 39. To that end, the cold mirror 33 is moved parallel to the optical axis 64 and thus, transversely relative to the beam-splitting interface 130 of the polarizing beamsplitter 34. The beam of visible light reflected by the cold mirror 33 moves transversely relative to the inclined plane of the beam-splitting interface 130 and the redirected beam of visible light moves horizontally with respect to the entrance face 133 of the quad-prism assembly 36. This has the effect of moving the major axis of the beam of green light, converted from the visible light by the input side of the quad-prism assembly 36, parallel to the major axis of the pixel array 39a of the green imager 39.

After the cold mirror 33 is moved, the optical path of light in the illumination subsystem 22 from the light source 26 to the planar surface of the pixel array 39a of the green imager 39 is either lengthened or shortened. The total length of the optical path must remain constant to retain a proper focus, for example, of the beam of green light at the green imager 39. To that end, the mounting plate 132 is moved relative to bracket 134 in the y-direction of coordinate frame 136 (FIGS. 14 and 15) to either increase or decrease the separation between the polarizing beamsplitter 34 and the cold mirror 33. Increasing the separation between the polarizing beamsplitter 34 and the cold mirror 33 corrects for a movement of the cold mirror 33 closer to relay lens 98 that reduces the total optical path.

The minor axis of the beam of green light is moveable in a direction parallel to the minor axis of the green imager 39 by moving the mounting plate 132 relative to bracket 134 in the x-direction of coordinate frame 136. As the mounting plate 132 is moved in the x-direction of coordinate frame 136, the beam of visible light reflected from the cold mirror 33 moves parallel to the inclined plane of the beam-splitting interface 130. If the mounting plate 132 is moved relative to bracket 134 to cause the beam of visible light to move down the inclined plane of the beam-splitting interface 130, the minor axis of the beam of green light moves in one direction parallel to the minor axis of the green imager 39. If the mounting plate 132 is moved relative to bracket 134 to cause the beam of visible light to move up the inclined plane of the beam-splitting interface 130, the minor axis of the beam of green light moves in another direction parallel to the minor axis of the green imager 39. Movement of the mounting plate 132 in the x-direction of coordinate frame 136 does not change the total optical path in the illumination subsystem 22 for a beam of light in transit from the light source 26 to the planar surface of the pixel array 39a of the green imager 39 and, therefore, a corrective focusing action is not required.

According to one aspect of the present invention, the position and angular orientation of each of the imagers 39, 41 and 43 can be adjusted in three dimensions, relative to the mounting plate 132, to optically align the beams of primary color light provided by the input side of the quad-prism assembly 36 with the appropriate one of the imagers 39, 41 and 43 for optimizing the brightness of the luminous flux on each. The alignment is preferably performed on a test stand while monitoring a stream of feedback information regarding the respective modulated output image of the appropriate one of the imagers 39, 41 and 43. After the imagers 39, 41 and 43 are aligned, the mounting plate 132 and its optical elements, which include the polarizing beamsplitter 34, the quad-prism assembly 36, the imagers 39, 41 and 43, and the projection lens 48, may be installed as a unitary assembly onto the bracket 134.

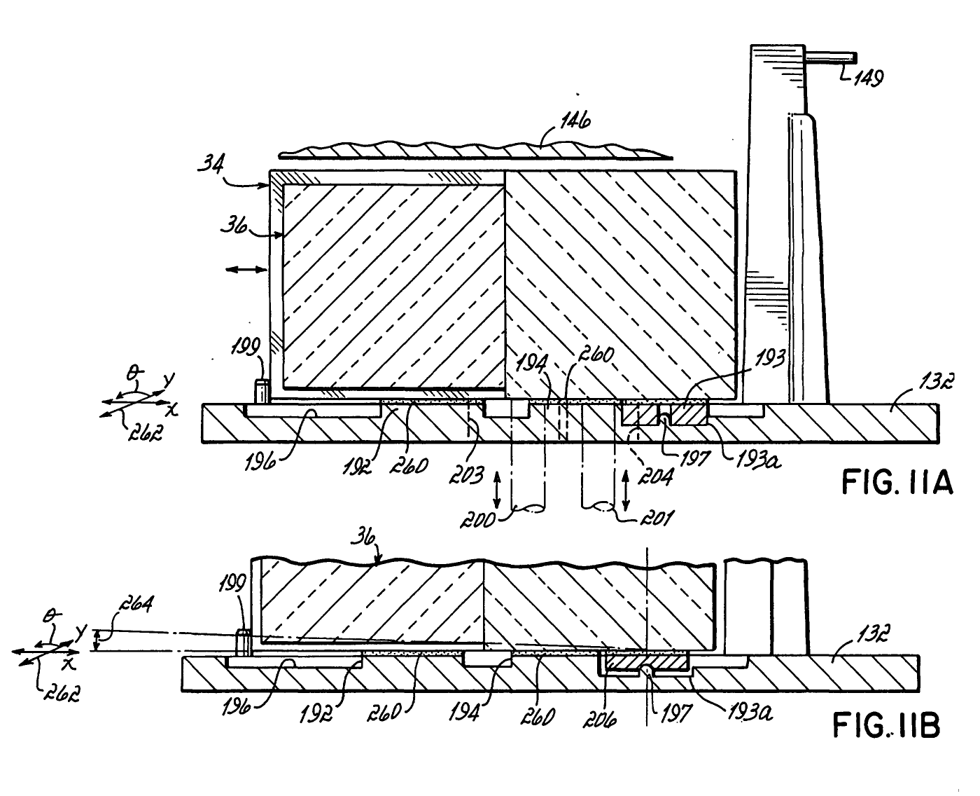

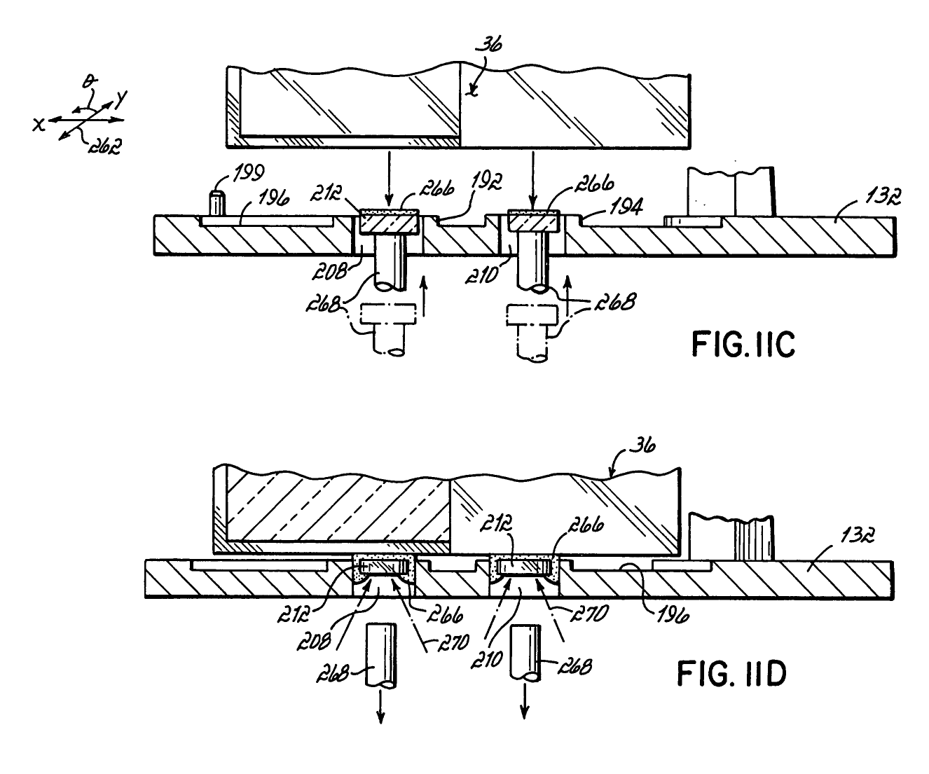

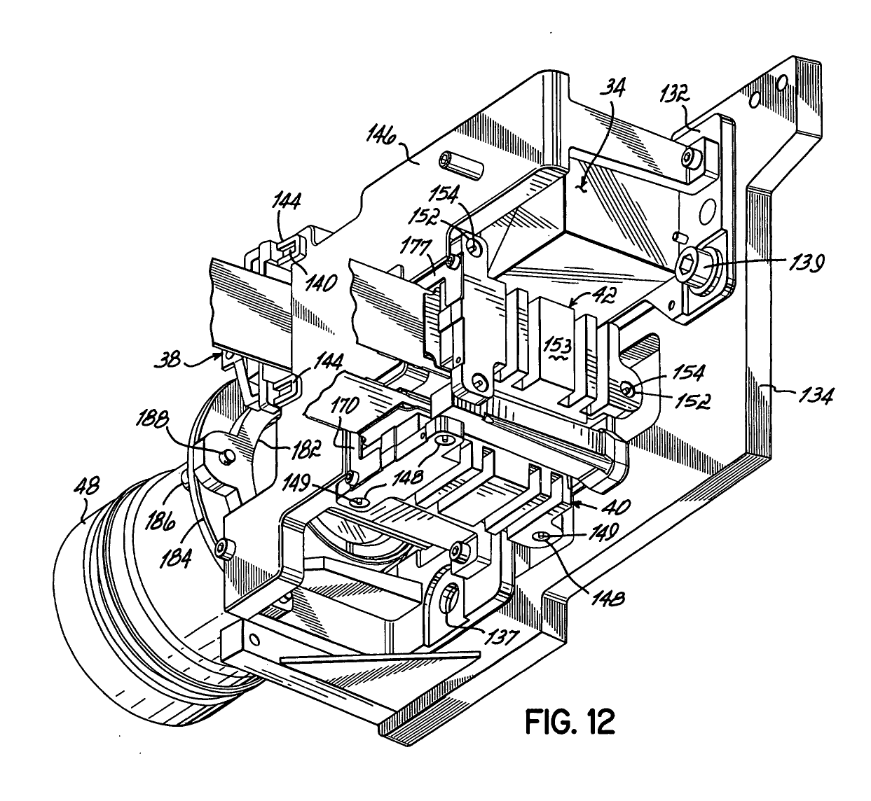

With reference to FIGS. 10, 12, 13 and 22-24, the green imager assembly 38 includes an imager mount 142 that holds the quarter-wave plate 44 adjacent to the pixel array 39a of green imager 39. Quarter-wave plate 44 is positioned to intercept the beam of green light incident from the nearby prism face of the quad-prism array 36 and to likewise intercept the modulated beam of green light emitted by the green imager 39 that reenters the nearby prism face. A flexible dust boot 300, formed of an elastomer, extends from the imager mount 142 to the nearby prism face of the quad-prism array 36. One open face of the dust boot 300 is attached to the prism face and the opposite open face of the dust boot is attached to the periphery of the imager mount 142. The dust boot 300 provides a substantially sealed passageway for the green light beam between green imager 39 and the prism face of the quad-prism array 36 that is sealed against the entry of particulate matter, such as dust, for the protection of the respective optical surfaces.

The imager mount 142 has a plurality of three cylindrical pins 140, as best shown in FIGS. 22-24, that project outwardly therefrom. One of the pins 140 projects outwardly from one face of the imager mount 142 and two of the pins 140 project outwardly from an opposite face of imager mount 142. Each pin 140 is received in one of a plurality of, for example, three half cylindrical bores 144 (best shown in FIGS. 10, 12 and 13), wherein one of the bores 144 is located on the mounting plate 132 and two of the bores 144 are located on a cover plate 146 that attaches to the mounting plate 132. Each bore 144 is significantly larger than the respective one of the pins 140 received therein so that, as the imager assembly 38 is moved in three dimensions as part of an alignment procedure, the pins 140 can likewise move while remaining positioned within the interior of the bores 144. The dust boot 300 conforms to the three-dimensional movement of the imager assembly 38 so that the isolated passageway between green imager 39 and the quad-prism array 36 is maintained as the imager assembly 38 is moved during the alignment procedure. When the three-dimensional position of the imager assembly 38 is optimized, imager mount 142 is held stationary and each bore 144 is filled with a quantity of an adhesive 145 (FIG. 13), such as an epoxy or an optical cement. When cured, the adhesive 145 secures the imager assembly 38 in its optimized three-dimensional position. A particularly useful adhesive 145 is an ultraviolet-curable optical cement that cures rapidly when exposed to ultraviolet radiation. A positional accuracy of about 2 μm or less is desired during the alignment procedure.

With reference to FIGS. 10, 12, 13 and 17-19, the red imager assembly 40 includes an imager mount 150 that holds the quarter-wave plate 45 adjacent to the rectangular pixel array 41a of red imager 41. Quarter-wave plate 45 is positioned to intercept the beam of red light incident from the nearby prism face of the quad-prism array 36 and to likewise intercept the modulated beam of red light emitted by the red imager 41 that reenters the nearby prism face. A flexible dust boot 302, formed of an elastomer, extends from the imager mount 150 to the nearby prism face of the quad-prism array 36. One open face of the dust boot 302 is attached to the prism face and the opposite open face of the dust boot is attached to the periphery of the imager mount 150. The dust boot 302 provides a substantially sealed passageway for the red light beam between red imager 41 and the prism face of the quad-prism array 36 that is sealed against the entry of particulate matter, such as dust, for the protection of the respective optical surfaces.

The imager mount 150 has a plurality of, for example, three bores 148, as best shown in FIGS. 17-19, that are triangularly spaced about the periphery thereof. Each of the bores 148 receives one of a plurality of three cylindrical pins 149, wherein two of the pins 149 are located on the mounting plate 132 and one of the pins 149 is positioned on the cover plate 146. Each bore 148 is significantly larger than the respective one of the pins 149 received therein so that, as the imager assembly 40 is moved in three dimensions as part of an alignment procedure to align the projection subsystem 24, the bores 148 can move and retain the respective one of the pins 149 within the cylindrical interior thereof. The dust boot 302 conforms to the three-dimensional movement of the imager assembly 40 so that the isolated passageway between red imager 41 and the quad-prism array 36 is maintained as the imager assembly 40 is moved during the alignment procedure. Imager mount 150 is held stationary after the three-dimensional position of the imager assembly 40 is optimized and each bore 148 is filled with a quantity of an adhesive (not shown), such as an optical cement or epoxy. When the adhesive is cured, it secures the imager assembly 40 in its aligned three-dimensional position.

With reference to FIGS. 10, 12, 13 and 20-21, the blue imager assembly 42 includes an imager mount 153 that holds the quarter-wave plate 46 adjacent to the rectangular pixel array 43a of blue imager 43. The blue imager assembly 42 is similar to the red imager assembly 40 described above. Quarter-wave plate 46 is positioned to intercept the beam of blue light incident from the nearby prism face of the quad-prism array 36 and to likewise intercept the modulated beam of blue light emitted by the blue imager 43 that reenters the nearby prism face. A flexible dust boot 304, formed of an elastomer, extends from the imager mount 142 to the nearby prism face of the quad-prism array 36. One open face of the dust boot 304 is attached to the prism face and the opposite open face of the dust boot is attached to the periphery of the imager mount 142. The dust boot 304 provides a substantially sealed passageway for the blue light beam between blue imager 42 and the prism face of the quad-prism array 36 that is sealed against the entry of particulate matter, such as dust, for the protection of the respective optical surfaces.

The imager mount 153 has a plurality of, for example, three bores 152, as best shown in FIGS. 20-21, that are triangularly spaced about the periphery thereof. Each of the bores 152 receives one of a plurality of three cylindrical pins 154, wherein two of the pins 154 are located on the mounting plate 132 and one of the pins 154 is positioned on the cover plate 146. The dust boot 304 conforms to the three-dimensional movement of the imager assembly 42 so that the isolated passageway between blue imager 43 and the quad-prism array 36 is maintained as the imager assembly 42 is moved during a three-dimensional alignment procedure. After the three-dimensional position of the imager assembly 42 is aligned, a quantity of an adhesive (not shown), such as an optical cement or an epoxy, is applied within the bores 152. The pins 154 are secured in the bores 152 after the adhesive cures to secure the imager mount 153 to mounting plate 132 and cover plate 146.

After the imager assemblies 38, 40 and 42 are positioned in three dimensions, the primary color images are focused and convergent. In an exemplary embodiment, the pins 140, 149 and 154 have a diameter of about 1 mm and an exposed length of about 5 mm and the bores 144, 148 and 152 have a diameter of about 4 mm and have a depth of about 4 mm. As a result, the respective imager assemblies 38, 40 and 42 are moveable over a radial distance in one plane of about 3 mm and over an axial distance perpendicular to that plane of slightly less than 4 mm. It is understood by those of ordinary skill in the art that the bores 144, 148 and 152 may be throughbores, blind bores or a combination thereof. It is also understood by those of ordinary skill in the art that the number of pins 140, 149 and 154 and bores 144, 148 and 152 may be varied and that other relatively three-dimensionally moveable combinations of complementary fastener structures are contemplated by the present invention. It is also understood by those of ordinary skill in the art that the locations of pins 140 on imager mount 142, of pins 149 on the cover plate 146 and the mounting plate 132, of pins 154 on the cover plate 146 and the mounting plate 132, of bores 144 on the cover plate 146 and the mounting plate 132, of bores 148 on the imager mount 150, and of bores 152 on the imager mount 153 may be varied. In addition, the bores and pins may be interchanged in relative locations so that, for example, pins 140 are located on the cover plate 146 and the mounting plate 132, and bores 144 are located on the imager mount 142.

As discussed above and as best shown in FIG. 22, the quarter-wave plate 44 is positioned between green imager 39 and the adjacent prism face of quad-prism assembly 36. Quarter-wave plate 44 is a rectangular optical element constructed of a birefringent material, such as quartz, mica or organic polymer, that introduces a phase difference of one-quarter cycle between the ordinary and extraordinary rays passing perpendicularly once therethrough. Quarter-wave plate 45, similar to quarter-wave plate 44, is associated with red imager 41 and quarter-wave plate 46, also similar to quarter-wave plate 44, is associated with blue imager 43. The quarter-wave plates 44, 45 and 46 modify the polarization of the modulated green, red and blue light output by imagers 39, 41 and 43, respectively, so that the output side of the quad-prism assembly 36 can properly route the three modulated primary color images to be combined and projected as a full-color image by the projection lens assembly 48.

With reference to FIGS. 10, 12, 13 and 22-24, quarter-wave plate 44 is held within an opening 159 provided in a waveplate bracket 156 that exposes and opaquely frames the rectangular pixel array 39a of green imager 39. An oversized slot 158 is provided in the waveplate bracket 156 to provide a passageway for the flexible ribbon cable, which is used to transmit image-forming information from an electronic control system to the pixel array 39a of the green imager 39. One end of the waveplate bracket 156 is pivotally attached by a conventional fastener 157, such as a socket head cap screw, to one end of the imager mount 142. The opposite end of the waveplate bracket 156 has an outwardly-extending flange 160 which extends beyond the backside of imager mount 142. A retainer spring 162, formed of a thin-walled metal, is affixed to the imager mount 142 and has a slotted opening 164 therein which overhangs a portion of the flange 160 having a threaded opening 165. A threaded fastener 166 is inserted into the slotted opening 164 and threadingly received in the threaded opening 165. When fastener 166 is tightened to secure the angular position of the waveplate bracket 156 relative to the imager mount 142, the retainer spring 162 provides a resilient coupling between the imager mount 142 and the waveplate bracket 156.

Pivoting the quarter-wave plate 44 relative to the rectangular pixel array 39a of green imager 39 adjusts or fine tunes the contrast ratio of the modulated beam of green light by darkening the darkened pixels and compensating for skew ray effects. As a result, the image quality of the green component of the full-color image is improved. The contrast ratio quantifies the brightness difference between the brightest and darkest parts of the projected image. Specifically, the waveplate bracket 156 holding quarter-wave plate 44 can be pivoted relative to the pixel array 39a of the green imager 39 through a small pivot angle, typically about ±2° relative to a vertical centerline reference, to maximize the contrast ratio of the modulated green component. The pivot angle is defined by the extent of the slotted opening 164. Fastener 166 is tightened to secure the angular orientation of the waveplate bracket 156 relative to the imager mount 142.

In accordance with one aspect of the present invention, the presence of the retainer spring 162 reduces or eliminates the transfer of torque from the threaded fastener 166 to waveplate bracket 156 as the fastener 166 is tightened. Specifically, the presence of the retainer spring 162 determines the direction of an advancement axis 246 along which the threaded fastener 166 is advanced and tightened to secure the waveplate bracket 156 and the quarter-wave plate 44 in the desired angular orientation relative to the imager mount 142. The advancement axis 246 is substantially orthogonal to a pivot axis 248 of the waveplate bracket 156 about the pivotable attachment to fastener 157. As a result, the amount of torque transferred from the fastener 166 to the waveplate bracket 156 along advancement axis 246 is insufficient to produce extraneous pivoting of waveplate bracket 156, relative to the imager mount 142, which might inadvertently alter the optimized orientation of quarter-wave plate 44 relative to the rectangular pixel array 39a of green imager 39 by pivoting about pivot axis 248 during the secureing operation.

With reference to FIGS. 10, 12, 13 and 17-19, quarter-wave plate 45 is held within an opening 167 provided in a waveplate bracket 168 that exposes and opaquely frames the rectangular pixel array 41a of red imager 41. One end of the waveplate bracket 168 is pivotally attached about a pivot axis 250 by a conventional fastener 169, such as a socket head cap screw, to one end of the imager mount 150. A C-shaped retainer spring 170, formed of a thin-walled metal, extends from the opposite end of the waveplate bracket 168 to the opposite end of imager mount 150. One arm of the retainer spring 170 is affixed to the imager mount 150. The other arm of the retainer spring 170 has an oval slot 172 that overlies a threaded opening 173 (FIG. 17) provided in the waveplate bracket 168. A threaded fastener 174 of a conventional type is inserted through the oval slot 172 and is threadingly received in the threaded opening 173. When threaded fastener 174 is tightened, the C-shaped retainer spring 170 provides a resilient coupling between the imager mount 150 and the waveplate bracket 168.

Pivoting the quarter-wave plate 45 about the pivot axis 250 relative to the rectangular pixel array 41a of red imager 41 adjusts or fine tunes the contrast ratio of the modulated beam of red light by darkening the darkened pixels and compensating for skew ray effects. As a result, the image quality of the red component of the full-color image is improved. The waveplate bracket 168 holding quarter-wave plate 45 is pivotable relative to the pixel array 41a of the red imager 41 through a small angle, typically about ±2° relative to a vertical centerline reference, to maximize the contrast. Threaded fastener 174 is tightened along an advancement axis 252 to secure the angular orientation of the waveplate bracket 168 relative to the imager mount 150.

In accordance with one aspect of the present invention, the presence of the C-shaped retainer spring 170 reduces or eliminates the transfer of torque from the threaded fastener 174 to waveplate bracket 168 as fastener 174 is threadingly received in the threaded opening 173. Specifically, the presence of the C-shaped retainer spring 170 determines the direction of the advancement axis 252 along which the fastener 174 is advanced and tightened to secure the waveplate bracket 168 and the quarter-wave plate 45 in the desired angular orientation relative to the imager mount 150. The advancement axis 252 is substantially orthogonal to the pivot axis 250 of the waveplate bracket 168 about the pivotable attachment about fastener 174. As a result, the amount of torque transferred from the fastener 174 to the waveplate bracket 168 is insufficient to produce extraneous pivoting of waveplate bracket 168 relative to the imager mount 150 which might inadvertently alter the optimized orientation of quarter-wave plate 45 relative to the rectangular pixel array 41a of red imager 41 during the securing operation.

With reference to FIGS. 10, 12, 13, 20 and 21, a waveplate bracket 176, similar to waveplate bracket 168, is provided to hold quarter-wave plate 46 adjacent to the rectangular pixel array 43a of the blue imager 43. A C-shaped retainer spring 177, similar to C-shaped retainer spring 170, and a threaded fastener 178 moveable in a slot 175 in retainer spring 177 are used to secure the angular position of the waveplate bracket 176 after the contrast of the beam of blue light has been optimized and the effects of skew rays have be compensated by rocking quarter-wave plate 46 about a pivot axis 254 relative to the rectangular pixel array 43a of the blue imager 43. The presence of the C-shaped retainer spring 177 defines the direction of an advancement axis 256 along which the fastener 178 is advanced and tightened to secure the waveplate bracket 176 and the quarter-wave plate 46 in the desired angular orientation relative to the imager mount 153. The advancement axis 256 is substantially orthogonal to the pivot axis 254 of the waveplate bracket 176 about the pivotable attachment to the imager mount 153. As a result, the amount of torque transferred from threaded fastener 178 to the waveplate bracket 168 is insignificant to cause extraneous pivoting when the bracket 168 is secured in the oriented position.

With reference to FIGS. 1-4, 10, 10A, 12, 13 and 15, the projection lens assembly 48 projects the combined modulated beams of primary-color light to produce a focused full-color image on the front or rear of a projection screen at a predetermined projection distance. The focal length of the projection lens assembly 48 produces a focused full-color image at the predetermined projection distance. The projection lens assembly 48, which is comprised of a plurality of optical lenses housed in a cylindrical barrel 258, magnifies the full-color image arriving from the output side of the quad-prism assembly 36 and projects the full-color image onto the projection screen. The area of the full-color image at the projection screen is significantly larger than the area of the full-color image emerging from the output side of the quad-prism assembly 36. For example, the full-color image arriving from the output side of the quad-prism assembly 36 may be about 1 inch diagonal and the full-color image at the projection screen may be about 35 inch diagonal.

Projection lens assembly 48 is moveable to compensate for directional misalignment between the light rays of the full-color image exiting the output side of the quad-prism assembly 36 and the optical axis of lens 48. Directional misalignment arises from manufacturing tolerances of the optical elements of light engine 20 and mispositioning and malpositioning in mounting and aligning the optical elements of the light engine 20. Directional misalignment produces a pointing error for the full-color image projected by projection lens assembly 48 on the projection screen.

To compensate for a pointing error, projection lens assembly 48 is adapted to be translated in two orthogonal dimensions of an x-y coordinate frame 179 (FIG. 10) relative to a mounting flange 180 (best shown in FIG. 10A) to facilitate alignment of the full-color image with the optical axis of lens 48. Mounting flange 180 is attached to one side edge of the mounting plate 132 and extends upwardly and outwardly from mounting plate 132. A circular opening 182 is provided in the mounting flange 180 to permit the passage of the beam of light comprising the full-color image to the input side of the projection lens assembly 48. The projection lens assembly 48 has an outwardly-extending, annular flange 184 with a plurality of, for example, three oversized throughbores 185. The diameter of each threaded fastener 186 is smaller than the diameter of the oversized throughbores 185. A plurality of tapped holes 188 are positioned with a spaced-apart relationship about the mounting flange 180 and arranged in a pattern that is alignable with the arrangement pattern of the oversized throughbores 185. The threaded fasteners 186 extend through the oversized throughbores 185 and are received in the tapped holes 188. When the threaded fasteners 186 are loosened, the projection lens assembly 48 is moveable in two orthogonal dimensions substantially parallel to the plane of the mounting flange 180. Projection lens assembly 48 is moveable to the extent that the threaded fasteners 186 are free to move within the diameter of the oversized throughholes 185. After the projection lens assembly 48 is aligned, the threaded fasteners 186 are tightened to secure the lens 48 in the aligned position.

According to one aspect of the present invention, the interior of an annular bearing washer 190 is positioned about the barrel 258 of the projection lens assembly 48 and is captured by the threaded fasteners 186 in a contacting relationship with the annular flange 184. Annular bearing washer 190 is formed of a thin-walled metal, such as a spring steel. When the threaded fasteners 186 are advanced and tightened, the amount of torque transferred to the projection lens assembly 48 is minimized or eliminated by the annular bearing washer 190. The annular bearing washer 190 dissipates any rotational movement as the threaded fasteners 186 are torqued to secure or fix the aligned position of lens 48 so that the torque is not transferred from fasteners 186 to the flange 184. As a result, the alignment of projection lens assembly 48 is not significantly affected or altered when the fasteners 186 are tightened.

The present invention permits the optical elements of the light engine 20 to be placed into a precise alignment for optimizing the properties of the full-color image that is projected by the light engine 20. The light engine 20 is lightweight so that a projection image display system 21 based on light engine 20 is significantly lighter than conventional projection image display systems. The light engine 20 is compact so that the footprint of projection image display system 21 based on light engine 20 is smaller than the footprint of conventional projection image display systems.

With reference to FIGS. 10, 10A and 10B, the quad-prism assembly 36 is attached to and supported by a pair of circular pads 192, 194 integral with the mounting plate 132. Pads 192, 194 are raised above other recessed portions 196 of the surface of the mounting plate 132. A quantity of a flexible adhesive 260, such as an elastomeric rubber, is applied to pads 192, 194. The adhesive 260 may incorporate multiple spherical glass beads that space the quad-prism assembly 36 from each of the pads 192, 194. It is appreciated that the geometrical shape of pads 192, 194 may differ without departing from the spirit and scope of the invention. For example, pads 192, 194 may be triangular. The pads 192, 194 may include openings 208, 210, shown in phantom in FIG. 10A, as described below.

When heated by operation of the light engine 20, the quad-prism assembly 36 will experience a thermal expansion which will differ from the thermal expansion of the metal of the pads 192, 194 to which two prism faces of assembly 36 are attached. The glass beads mixed with the adhesive will have an average maximum dimension that varies based upon the results of a thermal expansion calculation which provides an expected maximum expansion for the assembly. A typical maximum dimension for the glass beads will be about three times the expected maximum thermal expansion indicated by the calculation. A typical average diameter for spherical glass beads is about 75 μm. When assembled, the faces of the quad-prism assembly 36 adjacent to the mounting plate 132 contact only the pads 192, 194, as mediated by the adhesive 260. The polarizing beamsplitter 34 is also mounted to the three triangular pads 135 with the glass-bead filled flexible adhesive.

With continued reference to FIGS. 10, 10A and 10B, a plurality of, for example, two locating pins 198 are provided on the mounting plate 132 to serve as guides for the positioning of the quad-prism assembly 36 on the mounting plate 132. The locating pins 198 are located along a transverse axis of the quad-prism assembly 36. One of the pair of locating pins 198 is positioned at a recessed corner created by the intersection of the larger two of the four prisms of quad-prism assembly 36, which is approximately parallel to an axis that intersects the centroid of the assembly 36. The other of the pair of locating pins 198 prevents relative rotation between the quad-prisim assembly 36 and the mounting plate 132. The positioning of locating pins 198 reduces force concentrations applied to the quad-prism assembly 36. Similarly, a plurality of, for example, three locating pins 199 are provided adjacent to the polarizing beamsplitter 34 to serve as guides for positioning the beamsplitter 34. It is understood that the locating pins 198 and 199 can be incorporated into the structure of the assembly of the polarizing beamsplitter 34, the quad-prism assembly 36 and the mounting plate 132 or may be fixtures, as shown for pins 199 in FIG. 10A, that are removable from the assembly, such as with the aid of clearance holes extending through the thickness of the mounting plate 132.

According to the present invention and with continued reference to FIGS. 10, 10A and 10B, the quad-prism assembly 36 is optically aligned on a test stand and then installed as a unit onto the mounting plate 132. The mounting plate 132 is attached to the test stand, a quantity of the adhesive 260 is applied to each of the pads 192, 194. A precision gripper positions the quad-prism assembly 36 using the locating pins 198 such that the face of one prism of the quad-prism assembly 36 contacts the adhesive 260 on the pad 192 and the face of another prism of the assembly 36 rests on the adhesive 260 on the pad 194. The quad-prism assembly 36 is optically aligned with respect to the mounting plate 132. To that end, two arms 200, 201 of an alignment fixture are extended through a pair of spaced-apart throughbores 203, 204 provided in the mounting plate 132 and into contact with the rectangular prism faces of two prisms of the quad-prism assembly 36. The arms 200, 201 are attached to individual micromanipulators (not shown) that are used to perform the precision alignment while observing a stream of feedback information relating to the optical transmission properties of the quad-prism assembly 36. The alignment procedure orients the quad-prism assembly 36 relative to a planar x-y-θ coordinate frame 262. After the quad-prism assembly 36 is properly aligned and oriented, the arms 200, 201 maintain the quad-prism assembly 36 in the aligned condition relative to the mounting plate 132 until the optical adhesive cures and are then withdrawn from throughbores 203, 204. When assembled, the quad-prism assembly 36 only contacts the adhesive 260 on pads 192, 194, which reduces the conductive transfer of heat energy to the quad-prism assembly 36 from the mounting plate 132. The cover plate 146 is attached to the mounting plate 132 and is spaced from the prism surfaces of the quad-prism assembly 36 by intervening pads (not shown). The assembly of the mounting plate 132 and the quad-prism assembly 36 are mounted with conventional fasteners as a unit, after the remaining components are attached, to the bracket 134.

In an alternative embodiment and with reference to FIG. 11A, an annular disk 193, preferably formed of a metal, is positioned within a recess 193A formed on the mounting plate 132. The quad-prism assembly 36 contacts triangular pads 192, 194, as mediated by the adhesive 260, and one face of disk 193. Disk 193 is centered on and spatially constrained against significant movement by a rounded projection or detent 197 provided on the mounting plate 132. The two arms 200, 201 and the washer 196 provide three points of contact with the quad-prism assembly 36, which defines a plane in three dimensional space during alignment in the planar x-y-θ coordinate frame 262.

In another alternative embodiment and with reference to FIG. 11B, the attachment of quad-prism assembly 36 to the mounting plate 132 is accomplished by positioning a disk 206, preferably formed of a metal, on the crown of the detent 197, which operates as a fulcrum for the disk 206. The metal disk 206 is pivotable about a pivot point provided by the top of fulcrum 197 and, thereby, facilitates tilting of the quad-prism assembly 36 in the direction of double-headed arrow 264 with respect to the x-axis and in a second direction (into and out of the plane of the page of FIG. 11B) with respect to the y-axis during the alignment process. The utilization of the engagement between disk 206 and fulcrum 197 permits the quad-prism assembly 36 to be aligned relative to a rectangular two-dimensional coordinate frame space and oriented with an orthogonal set of three tilt angles relative to the origin of the two-dimensional coordinate frame 262.

In yet another alternative embodiment and with reference to FIGS. 11C-D, circular pad 192 is provided with a circular opening 208 and circular pad 194 is provided with an oval opening 210. Preferably, the major axis of oval opening 210 is aligned substantially with the center of circular opening 208, although the invention is not so limited. During the alignment operation for the quad-prism assembly 36, a quantity of an adhesive 266, such as an optical cement or an epoxy and which may be curable by ultraviolet radiation, is introduced into the openings 208, 210 to wet the adjacent surfaces of the quad-prism assembly 36 and the pads 192, 194. A disk 212 is inserted into each of the openings 208, 210. Disks 212 are formed of a material having a coefficient of thermal expansion that substantially similar to the coefficient of thermal expansion of the material forming the prisms of the quad-prism assembly 36 and having a bonding compatibility with the material forming the prisms of assembly 36. Usually, the material forming the prisms of the quad-prism assembly 36 is a glass that has a lower coefficient of thermal expansion than the material, usually a metal such as aluminum, forming the mounting plate 132. The disks 212 are formed of a glass. The presence of the disks 212 reduce the likelihood that the prisms of the quad-prism assembly 36 will be damaged due to the greater relative expansion of the mounting plate 132 and forces acting on the quad-prism assembly 36 at the adhered points of attachment to the mounting plate 132.

After the quad-prism assembly 36 is aligned relative to the planar x-y-θ coordinate frame 262, disks 212 are pressed by arms of a mounting fixture 268 against the respective proximate surface of the prism of quad-prism assembly 36 adjacent to the respective openings 208, 210. The adhesive 266 is captured between the disks 212 and the quad-prism assembly 36, and if radiation-curable, is cured by a timed exposure to radiation 270, such as ultraviolet light from a curing lamp, directed through the openings 208, 210 from the side of the mounting plate 132 opposite the quad-prism assembly 36. The ability to shine curing radiation directly on the adhesive 266 dramatically speeds the curing of the adhesive and, thereby, significantly reduces the time required to assemble the quad-prism assembly 36 and the mounting plate 132. A portion of the adhesive 266 adhesively bonds the outer periphery of each disk 212 with the mounting plate 132 about an inner periphery of the respective opening 208, 210. It is understood by those of ordinary skill in the art that a disk, similar to disks 212, and an opening, similar to openings 208 and 210, could be positioned underneath the polarizing beamsplitter 34 for purposes of correcting the mismatch in the coefficients of thermal expansion between the material of the polarizing beamsplitter 34 and the material of the mounting plate 132.

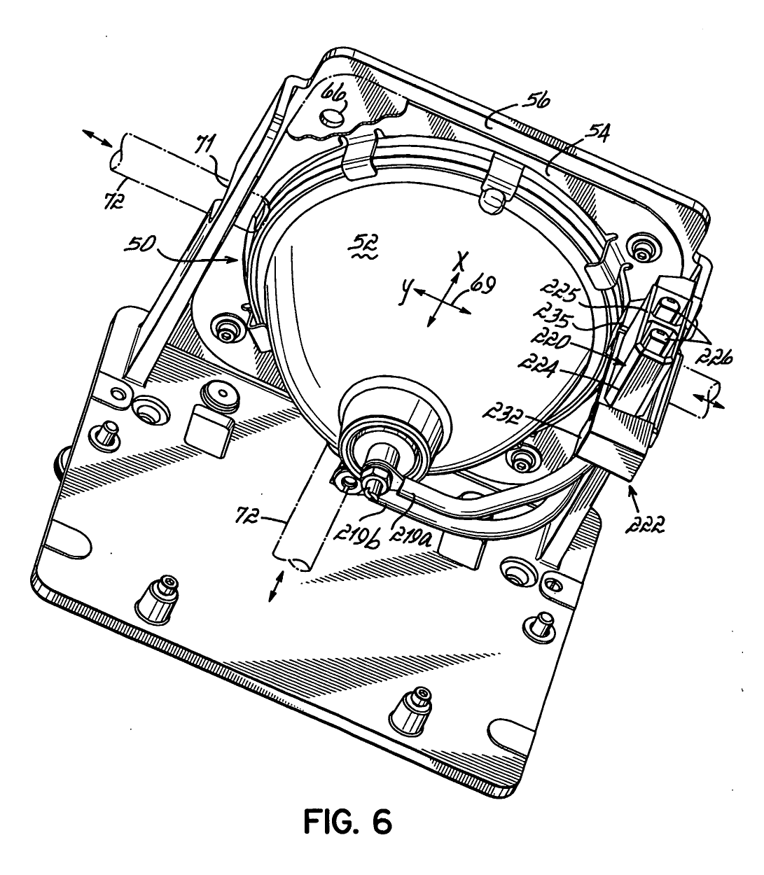

With reference to FIGS. 1, 4, 5, 5A, 5B and 6, the transmission line 161, which electrically connects lamp power supply 58 to the light source 26, is terminated by an electrical connector 218 (FIG. 3). Electrical connector 218 is affixed to the platform 242 by a socket clamp 221 (FIG. 3). Electrical connector 218 is engageable with a complementary electrical connector 220 removably held to the lamp housing 56 by a socket clamp 222. Socket clamp 222 is attached by conventional fasteners 217 to a slotted opening provided in outer housing portion 61b and fits within a rectangular notch 223 provided along an edge of outer housing portion 61a. As best shown in FIGS. 5 and 6, the electrical connector 220 is cabled via line 219a to an electrode of the lamp 50 and grounded via a line 219b to the backside of the reflector 52. Electrical connector 220 is accessible to the exterior of the light source 26 via a rectangular notch provided along a rear edge of the removable perforated rear cover 57.

With continued reference to FIGS. 1, 4, 5, 5A, 5B and 6, electrical connector 220 includes a connector body 224 which has a hollow interior that houses and aids in electrically isolating a pair of electrically-conducting prongs 226. A circumferential flange 225 projects outwardly from the rear of the connector body 224. Extending rearwardly from a rear surface of the connector body 224 is a pair of generally cylindrical connector portions 228, 229. A projection or ridge 230 extends longitudinally on connector portion 229.

Socket clamp 222 is attached to a side edge of the lamp housing 56 and is formed of a durable polymer, such as a nylon. Socket clamp 222 includes a base portion 232, a spaced-apart pair of side pillars 234, 235 extending outwardly and upwardly away from the base portion 232 in a spaced-apart relationship, a living hinge or resilient latch arm 236 extending outwardly away from the base portion 228, and a rigid latch arm 237 spaced apart from latch arm 236 and extending outwardly away from the base portion 232. A lip 238 is provided at the free end of the latch arm 237 that extends inwardly toward the opposing latch arm 236. The lip 238 is spaced apart from the base portion 232 by a gap or distance sufficient to accept a dimension of connector portion 228 of electrical connector 220 in a secure fit. When the curved side of connector portion 228 is positioned between the lip 238 and the base portion 232, lip 238 overhangs connector portion 228 and an arcuate concave inner surface of lip 238 contacts the curved side of the connector portion 229. The arcuate inner surface of lip 238 has a concave curvature that complements the convex curvature of the curved side of connector portion 228. The resilient latch arm 236 has a free end with a hook 239 having a concave surface 239a configured to engage the ridge 230 of connector portion 229 when the socket clamp 222 is in a latched condition. The pair of opposite engagements between lip 238 and connector portion 228 and between the hook 239 and the ridge 230 restrain the electrical connector 220 against vertical movement when the light source 26 is installed and removed from the cavity of the outer housing portions 61a, 61b.

Side pillar 234 has recess 240 and side pillar 235 has a recess 241 transversely spaced apart from recess 240 by a distance slightly greater than the transverse dimension of circumferential flange 225. The separation between the walls of the recesses 240, 241 defines a slotted opening sufficient to permit the connector body 224 to be removably inserted into the socket clamp 222. The engagement between the circumferential flange 225 and recesses 240, 241 provides resistance against pushout forces when the light source 26 is installed and resistance against pullout forces when the light source 26 is uninstalled.

As illustrated in FIG. 5B, electrical connector 220 is installed into socket clamp 222 by a procedure including the following installation steps. The electrical connector 220 is inclined at an angle and moved so that the connector portion 228 is inserted beneath lip 238 and against the arcuate inner surface of lip 238 and one side edge of the circumferential flange 225 is received in recess 241. Electrical connector 220 is then rotated, as indicated in FIG. 5A, to engage the other side edge of the circumferential flange 225 with the recess 240. As electrical connector 220 is rotated, the hook 239 of the resilient latch arm 236 contacts the ridge 230 of connector portion 229. In response, the resilient latch arm 236 resiliently deflects laterally outwardly away from connector portion 229. As the rotation of electrical connector 220 is continued, the electrical connector 220 contacts the base portion 232, the circumferential flange 225 seats fully within the recesses 240, 241, the hook 238 rides over the ridge 230 and latch arm 232 cantilevers inwardly, and the hook 238 resiliently engages with the ridge 230 to establish the latched condition.

While the present invention has been illustrated by a description of various embodiments and while these embodiments have been described in considerable detail, it is not the intention of the applicants to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicants' general inventive concept.

Having described the invention, what is claimed is:

1. A projection image display system that projects a full-color image onto a viewing surface, comprising:
an illumination subsystem operable to emit a beam of visible light, said illumination optical system including a cold mirror for reflecting the beam of visible light along a first optical axis;
a color-separation subsystem including an input optical element positioned relative to said first optical axis so as to receive the beam of visible light, said color-separation optical system operable to separate the beam of visible light into three beams of primary-color light;
a plurality of three light-modulating imagers, said three light-modulating imagers positioned relative to said color-separation optical system so as to receive a respective one of the three beams of primary-color light, each of said three light-modulating imagers including an active area operable to modulate the respective beam of primary-color light based on a given image signal to produce a respective beam of modulated primary-color light;
a color recombination subsystem operable to receive and combine the three beams of modulated primary-color light to form the full-color image; and
a projection lens assembly operable to project the full-color image synthesized by said color-combining optical system onto the viewing surface.

2. The projection image display system of claim 1 wherein said color-separation subsystem, said three light-modulating imagers, said color-combining subsystem, and said projection lens assembly are mounted on a mounting plate, and said cold mirror is moveable relative to said input optical element for aligning a first dimension of each of said beams of primary color light with a first dimension of said rectangular active area of the respective one of said three light-modulating imagers and said mounting plate is moveable in a first direction relative to said cold mirror for aligning a second dimension of each of said beams of primary color light with a second dimension of said rectangular active area of the respective one of said three light-modulating imagers.

3. The projection image display system of claim 1 wherein said illumination subsystem includes an optical element operable to angularly orient the first dimension of each of the beams of primary color light with the first dimension of the respective one of said three light-modulating imagers.

4. The projection image display system of claim 1 wherein said mounting plate is moveable in a second direction relative to said cold mirror for focusing one of said beams of primary color light at the respective locations of said rectangular active areas of one of said three light-modulating imagers.

5. The projection image display system of claim 1 wherein said color-combining subsystem includes one or more optical elements operable to adjust the contrast of the three beams of modulated primary-color light before projected as the full-color image onto the viewing surface by said projection lens assembly.

6. The projection image display system of claim 1 wherein said input optical element of said color-separation subsystem comprises a polarizing beamsplitter and said color-separation subsystem includes an input side of a quad-prism assembly.

7. The projection image display system of claim 1 wherein said color-combining subsystem includes an output side of a quad-prism assembly.

8. The projection image display system of claim 1 wherein said illumination subsystem includes a light source with a focal point and an optical integrator having a planar input face, said light source and said optical integrator aligned along a second optical axis, said light source moveable in a plane substantially parallel to said planar input face of said optical integrator for substantially aligning said focal point of said light source with a location in said plane of said planar input face that optimizes the transmission of light by said optical integrator.

9. An optical assembly for an illumination subsystem of a projection image display system, comprising
a lamp housing with an opening;
a reflector having a focal point for the reflection of light and a first optical axis along which said focal point lies;
an optical element having a second optical axis that is capable of being optically aligned with said first optical axis of said reflector to establish an aligned condition, said optical element having a planar end face positioned at said focal point of said reflector and said optical element operable to alter a property of the light in the optical path of the illumination system;
a light source operable to emit light for reflection by said reflector; and
a circumferential mounting flange holding said reflector in a position to reflect light from said light source through said opening in said lamp housing, said circumferential mounting flange moveable in two orthogonal directions relative to said lamp housing and in a plane at least substantially parallel to said planar end face of said optical element for establishing said aligned condition.

10. The optical assembly of claim 9 wherein said reflector has an ellipsoidal shape viewed parallel to the first optical axis from the perspective of said optical element.

11. The optical assembly of claim 9 wherein said optical element is an optical integrator that homogenizes the brightness of the beam of light provided by said light source and that shapes the beam of light.

12. The optical assembly of claim 9 wherein said lamp housing has a plurality of mounting posts of a first diameter extending toward said mounting flange and said mounting flange has a plurality of throughbores of a second diameter arranged to receive said plurality of mounting posts, said second diameter substantially greater than said first diameter so that said mounting flange is moveable in two dimensions relative to said lamp housing for aligning said first optical axis of said reflector with said second optical axis of said optical element.

13. The optical assembly of claim 9 wherein said mounting flange is moveable relative to said lamp housing for positioning said focal point with a positional accuracy of less than about 0.2 mm.

14. The optical assembly of claim 9 further comprising a projection image display system and wherein said optical assembly is a component of said projection image display system.

15. A mounting assembly for pivotally mounting an optical element in an illumination subsystem of a projection image display system, the optical element operable to alter a property of the light in the optical path of the illumination system, comprising:
a body member having a first arcuate bearing surface;
a cradle adapted to support the optical element on said body member, said cradle having a second arcuate bearing surface pivotal relative to said first bearing surface, said cradle rotatable within said body member through a range of tilt angles for rotating the optical element to a desired angular orientation; and
a mounting element configured to releasably secure said cradle to said body member at a selected tilt angle, said mounting element having a released condition to allow said cradle to move relative to said body member and a tightened condition to secure said cradle to said body member in the desired angular orientation, said cradle being substantially free of torque transferred from said mounting element to said cradle when said tightened condition is established so that the desired angular orientation is not misaligned during tightening.

16. The mounting assembly of claim 15 wherein said first bearing surface is concavely curved along a selected radius and said second bearing surface is convexly curved along a selected radius which is substantially equal to said first selected radius.

17. The mounting assembly of claim 15 wherein said cradle has a threaded opening, said body member has an access opening, and said mounting element further comprises a threaded fastener adapted to engage said threaded opening and an elongated nut positioned between said cradle and said lip, wherein movement of said threaded fastener relative to said threaded opening causes the opposite ends of said nut to engage opposite side portions of said body member adjacent to said access opening so as to secure the angular position of said cradle relative to said body member without transferring a significant torque to said cradle.

18. The mounting assembly of claim 15 wherein the angular orientation of said optical element can be varied over the range of about +5 degrees to about −5 degrees.

19. The mounting assembly of claim 15 wherein said body member has a spaced-apart pair of first bearing surfaces and said cradle has a spaced-apart pair of second bearing surfaces, each of said pair of first bearing surfaces contacting one of said pair of second bearing surfaces.

20. The mounting assembly of claim 19 wherein said first bearing surfaces are concavely curved along a selected radius and said second bearing surfaces are convexly curved along a selected radius which is substantially equal to said first selected radius.

21. The mounting assembly of claim 15 further comprising a projection image display system and wherein said mounting assembly is a component of said projection image display system.

22. An optical device for aligning a beam of light with an imager in a projection image display system, comprising:
a light-source operable to emit a beam of light;
a mirror having a reflective surface effective to reflect the beam of light in a first direction;
an optical element receiving the beam of light reflected from said reflective surface, said optical element having a planar interface capable of redirecting the beam of light in a second direction different than said first direction, the redirected beam of light irradiating the imager; and
an inclined mount holding said mirror, said inclined mount being moveable relative to said second optical element to reposition the beam of light reflected from said reflecting surface to thereby change the portion of said planar interface receiving the reflected light so that said second direction is shifted and the redirected light irradiates the imager at a second location different from said first location.

23. The optical device of claim 22 wherein said optical element is a polarizing beamsplitter having an inclined planar interface, said interface transmitting p-polarization rays and totally reflecting s-polarization rays so that light reflected from said optical element is separated into two polarized beams.

24. The optical device of claim 22 further comprising a chassis holding said light source, said mirror, said second optical element, and said inclined mount, said chassis having a spaced-apart pair of flat mounting surfaces and said inclined mount having a pair of substantially parallel arms, each of said pair of arms having an outwardly-extending flange that slidingly contacts one of said pair of flat mounting surfaces.

25. The optical device of claim 22 wherein the beam of light has a cross-sectional area and the imager has an active surface area, the cross-sectional area being greater than or equal to the active surface area, and said inclined mount is moveable relative to said second optical element for overlapping the cross-sectional area of the beam of light with the active surface area of the imager.

26. The optical device of claim 22 further comprising a projection image display system and wherein said optical device is a component of said projection image display system.

27. An optical apparatus for an illumination subsystem of a projection image display system that changes the travel direction of a planar beam of incident light relative to an optical element, the planar beam of incident light having a cross-sectional area, the optical apparatus comprising:
a light-generating device operable to generate the planar beam of incident light, said light-generating device directing the planar beam of incident light in a first direction;
an optical element positioned relative to said light-generating device to receive the planar beam of incident light, said optical element having a planar interface inclined relative to said first direction, said planar interface operable to redirect the planar beam of incident light in a second direction different than said first direction; and
a mounting plate holding said optical element, said mounting plate moveable relative to said frame along a first axis for changing the location at which the incident beam of light strikes said inclined planar interface and moveable relative to said frame along a second axis for changing the distance between said light-generating device and said optical element.

28. The optical apparatus of claim 27 wherein said optical element is a polarizing beamsplitter and said inclined interface transmits p-polarization rays and totally reflects s-polarization rays so that light reflected from said optical element is separated into two polarized beams and said interface redirect one of the two polarized beams in said second direction.

29. The optical apparatus of claim 27 wherein said light-generating device is a mirror.

30. The optical apparatus of claim 27 wherein said first and second axes are orthogonal.

31. The optical apparatus of claim 27 further comprising a projection image display system and wherein said optical apparatus is a component of said projection image display system.

32. A method for aligning an incident beam of light relative to an optical element in an illumination subsystem of a projection image display system, the incident beam of light having a cross-sectional area with a first major axis and a first minor axis orthogonal to the first major axis and the optical element having a planar active area with a second major axis and a second minor axis orthogonal to the second major axis, the first major axis substantially collinear with the second major axis, the method comprising:
providing a beamsplitter with an inclined planar interface operable to reflect a portion of the incident beam of light as a reflected beam of light having substantially the same cross-sectional profile as the incident beam of light, the reflected beam of light having a third major axis and a third minor axis orthogonal to the third major axis;
moving the first minor axis of the incident beam of light transverse with respect to the inclined planar interface to align the third minor axis of the reflected beam of light with the second minor axis of the active area; and
moving the inclined planar interface of the beamsplitter parallel to the first major axis of the incident beam of light to align the third major axis of the reflected beam of light with the second major axis of the active area.

33. The method of claim 34 wherein the beam of light has a rectangular cross-section viewed parallel to the optical path of the reflected beam of light.

34. The method of claim 32 wherein the beam of light has a rectangular cross-section viewed parallel to the optical path of the incident beam of light.

35. The method of claim 32 further comprising moving the inclined planar interface of the beamsplitter parallel to the optical path of the incident beam of light to maintain the total optical path length and light focusing at the two-dimensional active area of the optical element.

36. The method of claim 32 wherein the incident beam of light and the reflected beam of light have substantially the same cross-sectional profile.

37. An optical apparatus for aligning an active surface area of an imager relative to an optical axis in a projection subsystem of a projection image display system, the active surface area having a surface normal, comprising:
a frame; and
a mounting bracket holding the imager, one of said frame and said mounting bracket having a plurality of bores arranged about a periphery thereof and the other of said frame and said mounting bracket having a plurality of pins arranged about a periphery thereof, said pins capable of being three-dimensionally registered with said bores during an operation to align the surface normal of the active surface area of the imager with said optical axis, wherein pairs of said plurality of pins and said plurality of bores are adapted to be secured together to secure the position of the optical element relative to said bracket after the aligned condition is established.

38. The optical apparatus of claim 37 wherein said plurality of bores comprises three bores and said plurality of pins comprises three pins.

39. The optical apparatus of claim 37 wherein said bores are configured to receive and hold a quantity of an adhesive which is curable to maintain the aligned condition by fixing the positions of said plurality of pins in respective ones of said plurality of bores.

40. The optical apparatus of claim 37 further comprising a projection image display system and wherein said optical apparatus is a component of said projection image display system.

41. An optical assembly for a projection subsystem of a projection image display system, comprising:
a light imager having an active surface area, a first end and a second end, said active area emitting light;
a polarization device for shifting the phase of light emitted by said light imager; and
a bracket holding said polarization device adjacent to said active surface area, said bracket pivotally attached at a third end to said first end of said light imager so that said polarization device is rotatable relative to said light imager along a first axis, said bracket having a releasable securing mechanism at a fourth end to said second end of said light imager, said securing mechanism having a pivotal condition and a stationary condition, wherein said securing mechanism is configured so that torque applied to said securing mechanism to create the stationary condition is directed along a second axis different from said first axis.

42. The optical assembly of claim 41 wherein said polarization device is a quarter-wave plate.

43. The optical assembly of claim 41 wherein said second axis is substantially orthogonal to said first axis.

44. The optical assembly of claim 41 further comprising a projection image display system and wherein said optical assembly is a component of said projection image display system.

45. An alignment system for a projection subsystem of a projection image display system, comprising:
an imaging device having a first optical axis, a mounting surface and a plurality of threaded openings arranged about said mounting surface, said imaging device adapted to emit a beam of light at least substantially parallel to said first optical axis;
a projection lens assembly having a flange mounted to said mounting surface and positioned to receive the beam of light, said projection lens assembly having a second optical axis and said flange having a plurality of first throughbores alignable with said threaded openings of said mounting surface, said projection lens assembly moveable relative to said mounting surface for aligning said first optical axis of said imaging device with said second optical axis of said projection lens assembly to establish an aligned condition;
a bearing washer having a plurality of second throughbores alignable with said first throughbores and alignable with said threaded openings; and
a plurality of threaded fasteners, each threaded fastener having a threaded length and a head at one end of said threaded length, said threaded length of each threaded fastener insertable through said first and said second throughbores for threadable attachment with a respective one of said threaded holes to capture said bearing washer against said flange, said operable to prevent the transfer of torque from said heads of said threaded fasteners to said flange of said projection lens assembly when said fasteners are tightened against said bearing washer and said flange to secure said projection lens assembly in the aligned condition.

46. The alignment system of claim 45 wherein said bearing washer is rotatable relative to said flange so that torque is dissipated by rotation of said bearing washer.

47. The optical apparatus of claim 45 further comprising a projection image display system and wherein said alignment system is a component of said projection image display system.

48. An electrical connector clamp for securing an electrical connector in a light source for an illumination subsystem of a projection image display device, the electrical connector having a connector body with a first side edge, a second side edge spaced apart from the first side edge, and a circumferential flange, one side edge having an outwardly-extending ridge, the clamp comprising:
a clamp body having an slotted aperture, a clamp arm and an arcuate recess, the slotted aperture being dimensioned to receive opposite sides of the circumferential flange of the connector body, said arcuate recess having a lower surface and an overhanging upper surface separated by a distance sufficient to receive the first side edge of the connector body therebetween, said clamp arm configured to resiliently secure the ridge on the second side edge of the connector body, the clamp body securing the electrical connector against pullout forces.

49. The electrical connector clamp of claim 48 further comprising a projection image display system and wherein said electrical connector clamp is a component of said projection image display system.

50. An optical assembly for a projection image display system, comprising:
a mounting plate formed of a material having a first coefficient of thermal expansion, said mounting plate having a first throughbore and a second throughbore located in a spaced relationship;
an optical element formed of a material having a second coefficient of thermal expansion, said second coefficient of thermal expansion different from said first coefficient of thermal expansion, a first portion of said optical element covering one entrance to said first throughbore and a second portion of said optical element covering one entrance to said second throughbore;
a first and a second quantity of an adhesive; and
a first and a second circular disk, said first circular disk positioned in said first throughbore so-as to capture said first quantity of said adhesive therebetween, said second circular disk positioned in said second throughbore so as to capture said second quantity of said adhesive therebetween, said first and second disks formed of a material having a third coefficient of thermal expansion, said third coefficient of thermal expansion being between said first and said second coefficients of thermal expansion to reduce the likelihood that said optical element will be damaged at the adhered points of attachment by differences in the thermal expansion of said optical element and said mounting plate.

51. The optical assembly of claim 50 wherein said optical element is moveable relative to said mounting plate to establish an aligned condition, said first and said second quantities of adhesive are first and second quantities of a radiation-curable adhesive, and said disks are formed of a material transmissive of radiation having a wavelength to cure said radiation-curable adhesive for securing said optical element in the aligned position relative to said mounting plate.

52. The optical assembly of claim 50 wherein said second coefficient of thermal expansion is approximately equal to said third coefficient of thermal expansion.

53. The optical assembly of claim 50 wherein said second coefficient of thermal expansion and said third coefficient of thermal expansion are each less than said first coefficient of thermal expansion.

54. The optical assembly of claim 50 wherein said disks are circular and said first throughbore is circular and said second throughbore is oval so that said optical element is rotatable in a plane relative to said mounting plate.

55. The optical assembly of claim 50 further comprising a projection image display system and wherein said optical assembly is a component of said projection image display system.

56. A method of attaching an optical element to a mounting plate in a projection image display system, the optical element formed of a material having a first coefficient of thermal expansion and the mounting plate formed of a material having a second coefficient of thermal expansion, the first coefficient of thermal expansion being different from the second coefficient of thermal expansion, the method comprising:
providing the mounting plate with a circular throughbore and an oval throughbore, the circular throughbore and the oval throughbore having a spaced relationship;
positioning the optical element in a desired aligned position with respect to the mounting plate wherein a portion of the optical element covers one entrance to the oval throughbore and one entrance to the circular throughbore;
applying a quantity of an adhesive in an opposite entrance of the oval throughbore and an opposite entrance of the circular throughbore;
placing a first disk into the circular throughbore and into contact with the adhesive and a second disk into the oval throughbore and into contact with the adhesive, the first and the second disks formed of a material having a third coefficient of thermal expansion between the second and the third coefficients of thermal expansion; and
curing the adhesive to secure the optical element in the aligned position.

57. The method of claim 56 wherein the adhesive is a radiation-curable adhesive and the first and second disks are transmissive of radiation effective to cure the radiation-curable adhesive, and the curing comprises irradiating the radiation-curable adhesive with radiation effective to cure the adhesive and thereby secure the optical element in position relative to the mounting plate.

58. An optical assembly for a projection image display system, comprising:
a mounting plate having a first mounting pad and a second mounting pad spaced apart from said first mounting pad, said first and said second mounting pads raised above a recessed surface portion of said mounting plate;
a quantity of an adhesive applied to at least each of said first and said second mounting pads; and
an optical element positioned in a desired aligned position with respect to said mounting plate, wherein a first portion of said optical element contacts said adhesive on at least said first mounting pad and a second portion of said optical element contacts said adhesive on at least said second mounting pad, said adhesive being curable to affix said optical element in the desired aligned position.

59. The optical assembly of claim 58 further comprising a positioning element positioned on said mounting plate and a mounting device positioned proximate said positioning element, a quantity of an adhesive applied to a surface of said mounting device so that a third portion of said optical element contacts said adhesive on said mounting device.

60. The optical assembly of claim 59 wherein the mounting device is tiltable about said mounting element so that said optical element can be aligned with six degrees of freedom prior to curing the adhesive.

61. The optical assembly of claim 60 wherein the six degrees of freedom include three degrees of translation and three degrees of rotation.

62. The optical assembly of claim 59 wherein said positioning element is a fulcrum and said mounting device is an annular metal disk, said fulcrum configured and dimensioned to be received within an inner circumference of said annular metal disk.

63. The optical assembly of claim 58 further comprising a projection image display system and wherein said optical assembly is a component of said projection image display system.

64. A method of attaching an optical element to a mounting plate in a projection image display system, comprising:
providing the mounting plate with a first mounting pad and a second mounting pad, the first mounting pad and the second mounting pad projecting above a recessed surface portion of the mounting plate;
applying a quantity of an adhesive on each of the first and the second mounting pads;
positioning the optical element in a desired aligned position with respect to the mounting plate wherein a first portion of the optical element contacts the adhesive on the first mounting pad and a second portion of the optical element contacts the adhesive on the second mounting pad; and
curing the adhesive on the first and the second pads to affix the optical element in the desired position.

65. The method of claim 64 further comprising providing the mounting plate with a positioning element that projects above a recessed surface portion of the mounting plate, applying a quantity of an adhesive on a surface of the mounting plate, positioning a mounting device proximate the positioning element, and wherein the step of positioning includes positioning the optical element so that a third portion of the optical element contacts the mounting device and the step of curing includes curing the adhesive on the surface of the mounting plate.

66. The method of claim 65 further comprising, during the step of positioning, tilting the mounting device about the positioning element.

67. The method of claim 66 wherein the positioning element is a fulcrum and the mounting device is an annular metal disk, the fulcrum configured and dimensioned to be received within an inside circumference of the annular metal disk.

68. A lens mount for mounting a disk-shaped lens in an illumination subsystem of a projection image display system, comprising:
a body having a first mounting flange with an arcuate first mounting surface and a second mounting flange with an arcuate second mounting surface, said first and said second mounting flanges extending away from said body with a spaced relationship to define a recess capable of receiving the disk-shaped lens therein; and
a first resilient insert attached to the peripheral rim of the disk-shaped lens, said first resilient insert contacting a portion of said first mounting surface and thereby urging a first portion of the lens against said second mounting surface to ensure proper alignment.

69. The lens mount of claim 68 wherein said body has a base and a lid, said base carrying said first and said second flanges, said lid having a second resilient insert which contacts a second portion of the lens different from the first portion.

70. The lens mount of claim 68 wherein said portion of said first mounting surface is an arcuate shoulder and said first resilient insert is compressively captured between said shoulder and a facing surface of said disk-shaped lens.

71. The lens mount of claim 68 wherein said portion of said first mounting surface is an arcuate ledge and said first resilient insert is compressively captured between said ledge and a facing surface of said disk-shaped lens.

72. The lens mount of claim 68 further comprising a projection image display system and wherein said lens mount is a component of said projection image display system.

73. A projection image display system substantially as shown and described herein.
